(19) United States
(12) Patent Application Publication
(10) Pub. No.: US 2010/0272268 A1
(43) Pub. Date: Oct. 28, 2010

(54) ENHANCED HIGH-SPEED DOWNLINK SHARED CHANNEL SERVING CELL CHANGE PROCEDURES

(75) Inventors: Sharad Deepak Sambhwani, San Diego, CA (US); Bibhu Prasad Mohanty, San Diego, CA (US); Mehmet Yavuz, San Diego, CA (US); Rohit Kapoor, San Diego, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/731,872

(22) Filed: Mar. 25, 2010

Related U.S. Application Data
(60) Provisional application No. 61/164,017, filed on Mar. 27, 2009.

(51) Int. Cl. H04W 4/00; H04K 1/04

(52) U.S. Cl. 380/287; 370/331

(57) ABSTRACT

Serving cell change procedures are provided from a target cell that instructs a mobile device to change its serving cell to the target cell. Receiving the serving cell change instruction from the target cell can help mobile device to receive the instruction in areas were a signal from a current serving cell is rapidly deteriorating. An acknowledgement can be sent from mobile device to target cell and can be based on a scrambling code change and/or can be based on a CQI31.

### CROSS-REFERENCE

This is an application claiming priority to Provisional Application No. 61/164,017 entitled “ENHANCED HS-DSCH SERVING CELL CHANGE PROCEDURES IN UMTS” filed Mar. 27, 2009, and assigned to the assignee hereof and hereby expressly incorporated by reference herein.

### BACKGROUND

I. Field

The following description relates generally to communications systems and more particularly to serving cell changes in a communications system.

II. Background

Third Generation Partnership Project (3GPP) has standardized packet-switched air interfaces for downlink and uplink, referred to as High-Speed Downlink Packet Access (HSDPA) and High-Speed Uplink Packet Access (HSUPA), respectively. A difference on the downlink between HSDPA and prior circuit-switched air-interface (e.g., Release 99) is the absence of soft-handover in HSDPA. The data is transmitted to the user equipment (or mobile device) from a single cell referred to as the High-Speed Downlink Shared Channel (HS-DSCH) serving cell. As the user moves the mobile device across cell boundaries, the HS-DSCH serving cell changes. In comparison, in Release 99 channels, the mobile device receives data on dedicated channels (DCH) from all cells in its active set (which is updated as the mobile device is moved), also referred to as macro diversity. This difference has implications on the reliability with which signaling messages can be received at the mobile device.

For legacy serving cell change procedures, Radio Resource Control (RRC) signaling messages for changing the HS-DSCH serving cell (e.g., the Radio Bearer Reconfiguration message) are transmitted from the current HS-DSCH serving cell (source cell) and not the cell that the mobile device reports as being the stronger cell (target cell). Under conditions where the signal strength of the source cell deteriorates rapidly, the reliability of receiving RRC messages when mapped over the HS-DSCH may be reduced. Mapping Signaling Radio Bearers (SRBs or RRC signaling) over HS-DSCH is necessary to achieve high voice capacity over High Speed Packet Access (HSPA).

Legacy HS-DSCH Serving Cell Change (e.g., pre-release 8) procedures lead to unacceptably high call drop rates in realistic urban canyon conditions when SRBs are mapped on the HS-DSCH. Mapping SRBs on HS-DSCH is necessary to enable high capacity voice over HSPA (circuit switched voice or voice over Internet Protocol (VoIP) over HSPA).

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In accordance with one or more aspects and corresponding disclosure thereof, various aspects are described in connection with attempting to improve the performance of High-Speed Downlink Shared Channel (HS-DSCH) serving cell changes (SCC) under environments where a serving cell signal strength shows sudden degradation. The various aspects disclosed herein can enhance the HS-DSCH serving cell change procedure by involving a simple three-way handshake between mobile devices and Universal Mobile Telecommunications System (UMTS) Terrestrial Radio Access Network (UTRAN). The various aspects disclosed herein can have minimal impact on both mobile device and UTRAN implementations by utilizing existing channels to carry cell change indicator information and cell change confirm information on downlink and uplink respectively.

An aspect relates to a method for a serving cell change. Method comprises measuring a first pilot signal from a source node and a second pilot signal from a target node and determining second pilot signal is stronger than first pilot signal. Method also comprises sending measurements of first pilot signal and second pilot signal to an entity, receiving an indication from target node to switch to target node, and handing off to target node based on indication.

Another aspect relates to a wireless communications apparatus that comprises a memory and a processor. Memory retains instructions related to measuring a first pilot signal from a source node and a second pilot signal from a target node, determining the second pilot signal is stronger than the first pilot signal, sending measurements of the first pilot signal and the second pilot signal to an entity, receiving an indication from the target node to switch to the target node, and handing off to the target node based on the indication. Processor is coupled to memory and is configured to execute instructions retained in memory.

A further aspect relates to a wireless communications apparatus that facilitates changes to a serving cell. Wireless communications apparatus comprises means for measuring signal strengths of cells in an active set that comprises serving cell and a target cell and means for determining from the signal strengths that a first signal strength of serving cell is weaker than a second signal strength of target cell. Wireless communications apparatus also comprises means for sending a cell change request, means for receiving a cell change confirm from target cell, and means for switching from serving cell to target cell. According to an aspect, means for receiving comprises a means for receiving a physical layer indication from target cell. According to an aspect, means for receiving comprises a means for receiving a High Speed Shared Control Channel order.

In accordance with some aspects, wireless communications apparatus comprises means for obtaining a first scrambling code and a second scrambling code during a setup procedure, means for using first scrambling code to communicate with serving cell, and means for changing from first scrambling code to second scrambling code after means for receiving receives cell change confirm.

According to some aspects, wireless communications apparatus comprises means for selecting a subset of unused channel quality indicator bits, means for activating the subset, and means for transmitting the subset to target cell in response to cell change confirm.

An aspect relates to a computer program product comprising a computer-readable medium. Included in computer-readable medium is a first set of codes for causing a computer to measure pilot signals of nodes included in an active set. The active set comprises a source node and at least one target node. Computer-readable medium includes a second set of codes for causing computer to determine from the pilot signals that a pilot signal of source node is weaker than at least one pilot signal of at least one target node. Also included in computer-readable medium is a third set of codes for causing computer to request a handoff from source node to at least one target node and a fourth set of codes for causing computer to receive a handoff confirmation from at least one target node. Further, computer-readable medium includes a fifth set of codes for causing computer to acknowledge the handoff confirmation and a sixth set of codes for causing computer to handoff from source node to at least one target node.

Another aspect relates to at least one processor configured to facilitate a serving cell change. Processor comprises a first module for measuring a first pilot signal from a source node and a second pilot signal from a target node and a second module that determines second pilot signal is stronger than first pilot signal. Processor also comprises a third module that sends pilot signal measurements to an entity, a fourth module that receives an indication from target node to switch to target node, and a fifth module that hands off to target node based on indication.

A further aspect relates to a method performed by a target node for a serving cell change. Method comprises receiving from a network a notification that a serving cell of a mobile device should be changed from a source node to target node. Method also comprises sending an indication to mobile device that notifies mobile device of serving cell change and detecting mobile device handed off to target node.

Another aspect relates to a wireless communications apparatus that comprises a memory and a processor. Memory retains instructions related to receiving from a radio network controller a radio resource control message that indicates a serving cell of a mobile device is to be changed to wireless communications apparatus, transmitting a cell change indicator to mobile device, and determining wireless communications apparatus is serving mobile device. Processor is coupled to memory and is configured to execute instructions retained in memory.

An aspect relates to wireless communications apparatus that performs a serving cell change. Wireless communications apparatus includes means for receiving an indication that a serving cell of a mobile device is to be changed to wireless communications apparatus and means for notifying mobile device of serving cell change. Also included in wireless communications apparatus is means for detecting a completion of serving cell change and means for informing a network entity of the completion. According to some aspects, means for detecting comprises means for measuring a change from a first scrambling code to a second scrambling code and means for determining the mobile device has switched from the first scrambling code to the second scrambling code.

Another aspect relates to a computer program product comprising a computer-readable medium. Included in computer-readable medium is a first set of codes for causing a computer to receive from a radio network controller a radio resource control message that indicates a serving cell of a mobile device is to be changed to wireless communications apparatus. Also included in computer-readable medium is a second set of codes for causing computer to transmit a cell change indicator to mobile device and a third set of codes for causing computer to determine wireless communications apparatus is serving mobile device.

An aspect relates to at least one processor configured to facilitate serving cell changes. Processor includes a first module that receives from a network a notification that serving cell of a mobile device should be changed from a source node to a target node. Processor also includes a second module that sends an indication to mobile device that notifies mobile device of a serving cell change and a third module that detects mobile device handed off to target node.

To the accomplishment of the foregoing and related ends, one or more aspects comprise features hereinafter fully described and particularly pointed out in the claims. The following description and annexed drawings set forth in detail certain illustrative features of one or more aspects. These features are indicative, however, of but a few of various ways in which principles of various aspects may be employed. Other advantages and novel features will become apparent from the following detailed description when considered in conjunction with the drawings and the disclosed aspects are intended to include all such aspects and their equivalents.

### BRIEF DESCRIPTION OF THE DRAWINGS

FIG. 1 illustrates a wireless communications environment that utilizes high-speed downlink shared channel serving cell change procedures, according to an aspect.

FIG. 2 illustrates a call flow of a serving cell change procedure, according to an aspect.

FIG. 3 illustrates a system that utilizes HS-DSCH serving cell change procedures in UMTS, according to an aspect.

FIG. 4 illustrates a call flow that can be utilized for scrambling code change, according to an aspect.

FIG. 5 illustrates a flow diagram of a modified Fast Serving Cell procedure based on uplink scrambling codes, according to an aspect.

FIG. 6 illustrates a schematic representation of timing of dual scrambling codes detection at Node B, according to an aspect.

FIG. 7 illustrates a flow diagram of a Fast Serving Cell (FSCC) procedure based on CQI31, according to an aspect.

FIG. 8 illustrates a call flow for indicating a serving cell change, according to an aspect.

FIG. 9 illustrates a system that facilitates cell changes in accordance with one or more of the disclosed aspects.

FIG. 10 is an illustration of a system that facilitates serving cell change procedures using acknowledgements in accordance with various aspects presented herein.

FIG. 11 illustrates an example system that facilitates serving cell change procedures, according to an aspect.

FIG. 12 illustrates an example system that is configured for High-Speed Downlink Shared Channel serving cell change procedures in Universal Mobile Telecommunications System, according to an aspect.

FIG. 13 illustrates a multiple access wireless communication system according to one or more aspects.

FIG. 14 illustrates an example wireless communication system, according to an aspect.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing these aspects.

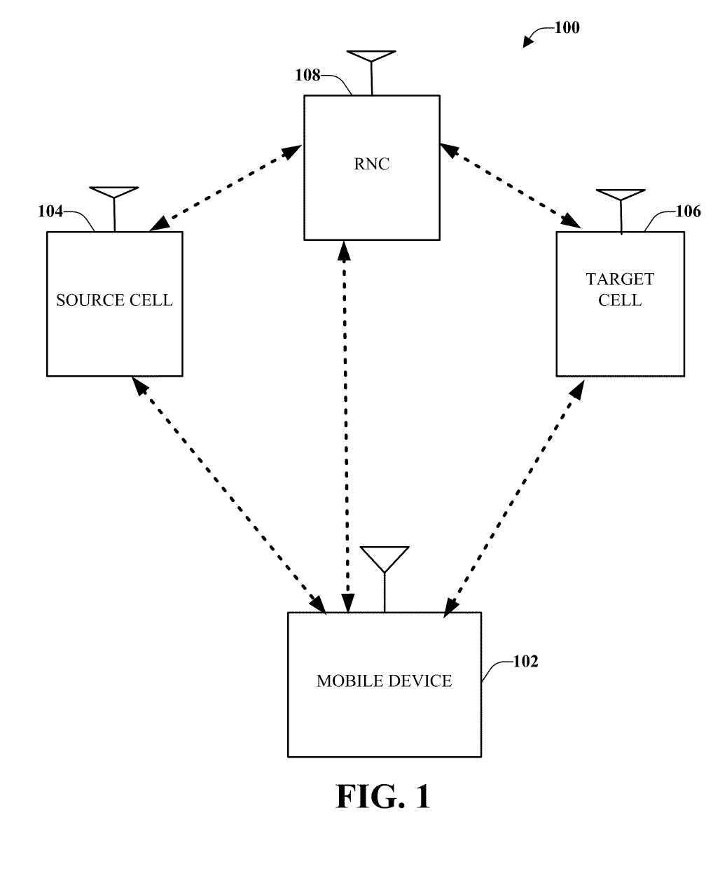

FIG. 1 illustrates a wireless communications environment 100 that utilizes high-speed downlink shared channel serving cell change procedures, according to an aspect. An advantage of the disclosed aspects is the reusability of existing call set up procedures. Another advantage is robustness in detecting the physical reconfiguration of the mobile device within the Universal Mobile Telecommunications System (UMTS) Terrestrial Radio Access Network (UTRAN) as fast as possible.

Included in wireless communications environment 100 is a mobile device 102 that is configured to be moved from one geographic area to another geographic area within wireless communications environment 100. As mobile device 102 is moved, its current serving cell (source cell 104) might no longer be effective in handling communications for mobile device 102, and it might be desirable to switch to a different cell (target cell 106). It should be understood that wireless communications environment 100 can include a plurality of mobile devices and a multitude of cells, however, only one mobile device, one source cell, and one target cell are shown for purposes of simplicity.

According to traditional Serving Cell Change (SCC) procedures, mobile device 102 receives a Radio Resource Control (RRC) message on source cell 104 before switching to target cell 106. An RRC message, which is the control signaling layer in High Speed Packet Access (HSPA), instructs mobile device 102 to change to a different base station (e.g., to target cell 106). However, under conditions where signal strength of source cell 104 is rapidly deteriorating, it may not be possible for mobile device 102 to reliably decode the RRC message from source cell 104. For example, measurements taken in dense urban areas confirm that fast changing path loss conditions exist where path loss may increase by 25 dB or more in less than a second. In the case where there is a sudden degradation in signal quality, mobile device might not receive the RRC message due to the signal quality or due to other issues, which can cause communication failures (e.g., call drop) or other problems resulting in undesirable user experiences. Thus, existing High-Speed Downlink Shared Channel (HS-DSCH) Serving Cell Change procedures cannot ensure reception of relevant serving cell change control information in challenging channel environments, such as dense urban canyon environments. The disclosed aspects provide for a more reliable and robust serving cell change for scenarios where source cell signal quality degrades quickly.

RRC signaling can be made reliable by carrying Signaling Radio Bearers (SRBs) on Dedicated Channels (DCHs) since DCHs can be soft combined from multiple cells. However, dedicated channels can use an excessive amount of code space on downlink because dedicated channels need to be allocated to multiple cells, which can lead to a significant loss of capacity for Voice Over Internet Protocol (VoIP) (e.g., measurements indicate around a forty percent capacity loss) as well as loss of spare capacity for Best Effort for a given number of VoIP calls. The disclosed aspects solve the serving cell change problem for the case where the signaling is not mapped to dedicated channels (there is no soft combining from multiple cells) while maintaining reliability for serving cell change.

Voice communication has tight requirements for service outage during cell change. For VoIP or Circuit-Switched (CS) voice on High Speed Packet Access (HSPA) to be a successful service, the service should meet about the same level of quality and reliability requirements as CS voice. An important performance metric is the reliability of the current serving cell change procedures under Urban Canyon conditions. To achieve high voice capacity, an appropriate configuration for VoIP is to carry SRBs on HS-DSCH, while configuring Fractional Dedicated Channel (F-DPCH) to carry power control bits. Thus, if high voice or spare Best Effort capacity is desired under Urban Canyon conditions, then the robustness of the serving cell change procedure needs to be guaranteed when SRBs are mapped on the HS channels.

The disclosed aspects can improve performance of HS-DSCH serving cell changes under environments where source cell 104 signal strength shows sudden degradation (“urban canyon” environments or dense urban areas, such as downtown areas of many cities). In accordance with some aspects, a simple three-way handshake between mobile device and Universal Terrestrial Radio Access Network (UTRAN) can enhance the HS-DSCH Serving Cell Change Procedure. The various aspects disclosed herein can have minimal impact on both mobile device and UTRAN implementations by making use of existing channels to carry cell change indicator information and cell change confirm information on downlink and uplink respectively.

In accordance with some aspects, mobile device 102 sends an Event 1A to a radio network controller (RNC 108). Event 1A is triggered to add a new cell to mobile device's active set. Mobile device 102 is pre-loaded with serving cell related information through an Active Set Update Message. Cells in the active set are also pre-loaded with serving cell configuration and transport bearers are set up. At substantially the same time as transmitting an Event 1D (e.g., when a target cell becomes stronger than the current serving cell), mobile device 102 begins listening to a particular channel (e.g., a pre-assigned High Speed Shared Control Channel (HS-SCCH) code) on target cell 106 for indication of serving cell change, while still decoding data from source cell 104. At about the same time as receiving Event 1D, RNC 108 begins to bicast data to source cell 104 and target cell 106. Bicasting data can minimize data interruption for real-time services such as voice and should be considered an optional part of this procedure. RNC 108 also instructs target cell 106 to indicate change of serving cell to mobile device 102. Target cell 106 indicates change of serving cell to mobile device on a particular channel. At about the same time as receiving indication of serving cell change (e.g., receiving an order on the pre-assigned HS-SCCH code) from target cell 106, mobile device 102 reconfigures to target cell 106 using pre-configured information. Mobile device 102 sends an indication on the uplink acknowledging this change, which is received by at least target cell 106. Target cell 106 starts serving mobile device 102 (source cell 104 stops serving mobile device 102). Target cell 106 informs RNC 108 of the successful change in serving cell. At substantially the same time as receiving the successful change information, RNC 108 stops bicasting.

If target cell falsely detects an acknowledgement (from mobile device) that the serving cell change was successful, then mobile device may be served some data prematurely by target cell. This can result in some loss of data. If target cell misses the acknowledgement, the consequence can be more severe. Target cell may assume mobile device has not yet performed the serving cell change where in fact mobile device has switched to target cell. This could eventually lead to a dropped call. Thus, the uplink acknowledgement should be received with high reliability to guarantee both NodeB and mobile device perform correctly in timing. Information related to uplink acknowledgement is described in further detail below.

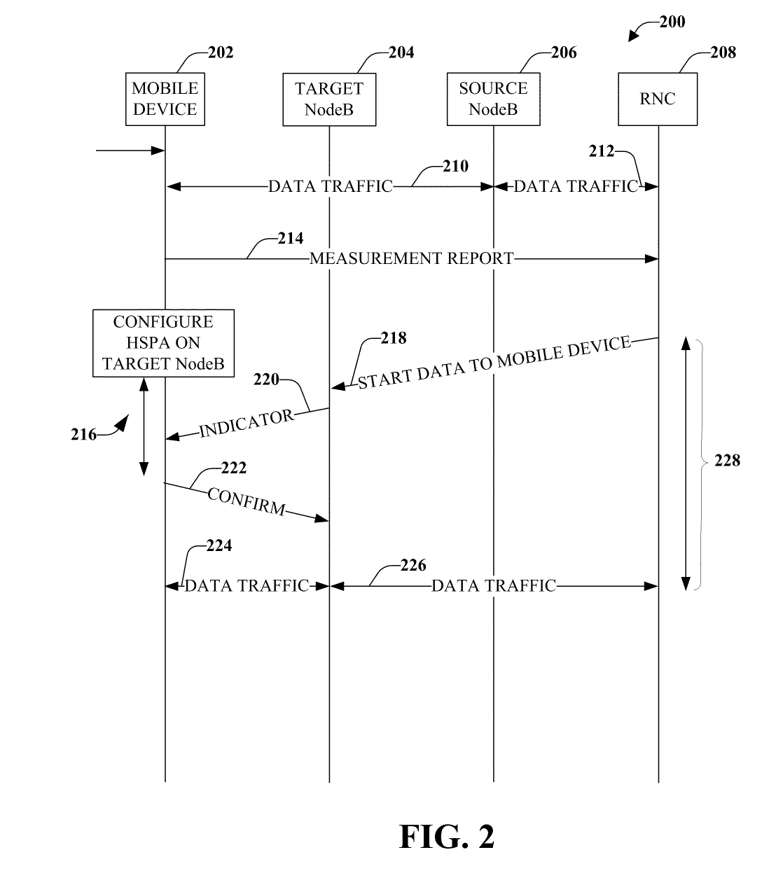

FIG. 2 illustrates a call flow 200 of a serving cell change procedure, according to an aspect. In an example, in an urban canyon environment, a mobile device might be carried in a vehicle. As that vehicle is moved, a serving cell (source cell) of mobile device might suddenly have a signal that is not as strong as a signal from a different cell (target cell). For example, mobile device might be receiving a line-of-sight signal from source cell. After the vehicle moves around a corner, the signal from the source cell is obstructed and is no longer a line-of-sight signal but a reflected signal and a serving cell change might be appropriate.

Call flow 200 of FIG. 2 illustrates block representations of a mobile device 202, a target cell (Target NodeB 204), a source cell (Source NodeB 206), and a radio network controller (RNC 208). According to RRC procedures, HS-DSCH serving cell change can be either synchronized or unsynchronized. For synchronized, the network indicates an activation time at which mobile device will perform the serving cell changes. Since network does not know how long it will take the RRC reconfiguration message (such as Physical Channel Reconfiguration (PCR)/Transport Channel Reconfiguration (TCR)/Radio Bearer Reconfiguration (RBR)) to be transmitted over source cell nor does network know how long mobile device will take to reconfigure on receiving the message, network has to assume the worst-case. Thus, network typically indicates a conservative activation time, leading to a potentially large interruption for voice traffic, particularly if source cell signal strength has degraded.

Under unsynchronized serving cell change procedure, network indicates an activation time of “now”. Thus, mobile device begins listening to target cell when mobile device receives RRC reconfiguration message and finishes if reconfiguration is successful. This procedure does not need to assume the worst-case reception time of RRC reconfiguration message at mobile device and can be more suited for voice traffic.

The performance of unsynchronized serving cell change procedure can have high call drops under Urban Canyon conditions or under scenarios of high mobility with antennas downtilt in NodeBs. A reason for these call drops is that mobile device needs to receive the PCR/RBR/TCR message from serving cell, which may be degrading fast under some conditions.

As mentioned, mobile device 202 needing to receive the PCR/RBR/TCR message from source NodeB 206 is a reason for reduced robustness of current SCC procedures. The disclosed aspects provide enhancements to the SCC procedure, which can allow mobile device 202 to be signaled of the change in serving cell by target NodeB 204, while still maintaining control of the overall procedure at RNC 208. To enable this, mobile device 202 is configured to receive the serving cell related information (currently carried in PCR/RBR/TCR message) in an Active Set Update message, according to an aspect.

The various aspects can be summarized by the general call flow 200 of FIG. 2. Mobile device 202 receives/sends data traffic 210 from/to Source NodeB 206, which is receiving/sending data traffic 212 from/to RNC 208. Mobile device 202 is also measuring pilot signals from various nodes (e.g., Source NodeB 206, Target NodeB 204, as well as other nodes from which mobile device 202 can receive pilot signals). Based on these measurements, mobile device 202 might determine that a pilot signal received from Target NodeB 204 is stronger than a pilot signal received from Source NodeB 206. In this case, mobile device 202 conveys a measurement report 214 to RNC 208. Measurement report 214 informs RNC 208 that target NodeB 204 is stronger than serving NodeB 206 and that it might be beneficial for mobile device 202 to switch from Source NodeB 206 to Target NodeB 204. HSPA 216 is configured on Target NodeB 204.

Based on the received measurement report 214, RNC 208 sends a notification 218 to Target NodeB 204 to start data to mobile device 202. Target NodeB 204 transmits a cell change indicator 220 to mobile device 202. Cell change indicator 220 instructs mobile device 202 to change cells (e.g., handoff to Target NodeB 204). The indicator is not sent by Source NodeB 206. Based on cell change indicator 220, mobile device 202 changes its serving cell from Source NodeB 206 to Target NodeB 204 and transmits a cell change confirmation 222 to Target NodeB 204 (this cell change confirmation may also be heard by Source NodeB 206). Mobile device 202 can exchange data traffic 224 with Target NodeB 204 and Target NodeB 204 exchanges data traffic 226 with RNC 208. During the time represented at 228, there may be data bicasting to Source NodeB 206 and Target NodeB 204.

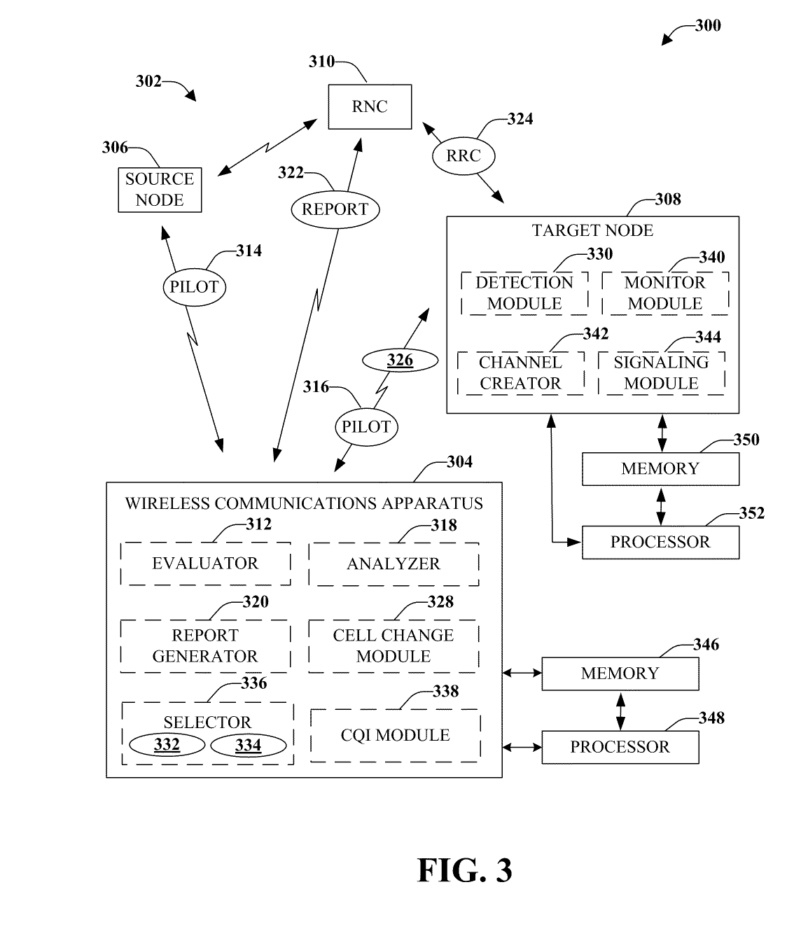

FIG. 3 illustrates a system 300 that utilizes HS-DSCH serving cell change procedures in UMTS, according to an aspect. System 300 is configured to reuse existing call setup procedures and can detect the physical reconfiguration of a mobile device within UTRAN as soon as possible. System 300 is configured to allow mobile device to be signaled of a change in serving cell by the target cell, while still maintaining control of the overall procedure at the RNC.

System 300 can be utilized in a wireless communications environment 302. Included in system 300 is a wireless communication apparatus 304 (e.g., mobile device) that is configured to receive data signals from a Serving NodeB (source node 306) and Target NodeB (target node 308). It should be understood that system 300 (and/or wireless communications environment 302) can include more nodes and more wireless communications apparatuses, however, only two nodes and a single wireless communications apparatus are illustrated for purposes of simplicity. Also included in wireless communications environment 302 is an RNC 310 that is in communication with wireless communications apparatus 304, source node 306, and target node 308.

Wireless communications apparatus 304 includes an evaluator 312 that is configured to measure pilot signals received from one or more nodes (e.g., source node 306, target node 308, and so forth). For example, wireless communications apparatus 304 might be exchanging data with source node 306 (which is the current serving node of wireless communications apparatus 304). While exchanging data, wireless communications apparatus 304 receives a pilot signal 314 from source node 306 and a pilot signal 316 from target node 308 (as well as pilot signals from other nodes). A strength of each pilot signal 314, 316 can be measured by evaluator 312.

An analyzer 318 is configured to determine whether a serving cell change should occur. For example, if strength of pilot signal 314 of source node 306 is stronger than pilot signal 316 of target node 308 (and signals for other nodes), there is no need to change a serving node of wireless communications apparatus 304. However, if measured strength of pilot signal 316 of target node 308 is equal to or greater than pilot signal 314 of source node 306, it might be beneficial to change serving node of wireless communications apparatus 304 (e.g., switch from source node 306 to target node 308).

If analyzer 318 determines a serving cell change should occur, a report generator 320 creates a report and sends the report 322 to RNC 310. Report 322 is configured to inform RNC 310 that strength of pilot signal 316 of target node 308 is stronger than strength of pilot signal 314 of source node 306. In accordance with some aspects, report 322 can include the signal strength information and/or other information. In accordance with some aspects, the measurement report is sent as an Event 1A, which can be configured when a signal strength of target node 308 has come within a certain dB of signal strength of source node 306. In accordance with some aspects, the measurement report is transmitted as an Event 1D, which can be configured when a target node 308 becomes stronger than source node 306.

Based on the received report 322, RNC 310 can send an RRC message 324 to target node 308 (which can be received by a receiver component of target node). RRC message 324 instructs target node 308 of a serving cell change. Target Node 308 (though use of a transmit component) sends an indication 326 to wireless communications apparatus 304 to notify wireless communications apparatus 304 to change its serving cell to target node 308. Wireless communications apparatus 304 may not receive an indication from source node 306. A cell change module 328 is configured to handoff wireless communications apparatus 304 from source node 306 to target node 308 based on received indication 326.

A detection module 330 can ascertain that wireless communications apparatus 304 has handed off to target node 308. According to some aspects, target node 308 notifies RNC 310 that a cell change has occurred. For example, a cell change complete message can be transmitted to RNC 310.

Since RRC message 324 is bulky with lengthy information, indication 326 from target node 308 can be physical layer indication that carries a small amount of information, which can make serving cell changes quicker. Thus, the disclosed aspects can provide both reliability for serving cell changes as well as a faster serving cell change.

In accordance with some aspects, wireless communications apparatus 304 can notify target node 308 that wireless communications apparatus 304 has received indication 326, which completes the handshake. According to this aspect, wireless communications apparatus 304 is provided a first scrambling code 332 and a second scrambling code 334, which can be provided during an RRC connection setup (and received by a receiver component of wireless communications apparatus 304). If wireless communications apparatus 304 (e.g., a transmit component) is using first scrambling code 332 to communicate with source node 306, at substantially the same time as handing off to target node 308, a scrambling code selector 336 changes to second scrambling code 334. Scrambling code change is detected by both source node 306 and target node 308. For example, detection module 330 can ascertain that wireless communications apparatus 304 has handed off to target node 308 based on detection of the scrambling code change.

For a short period of time, wireless communications apparatus 304 can monitor an HS-SCCH from target node 308 while still decoding data from source node 306. A change in uplink scrambling code can also be used in the Fast Reconfiguration procedure to allow NodeBs to detect that wireless communications apparatus has reconfigured after receiving the radio bearer setup message, which allows faster radio bearer setup.

In accordance with some aspects, to acknowledge receipt of indication 326, wireless communications apparatus 304 can transmit a special combination of bits based on a channel quality indicator (CQI) channel. The CQI channel can be used to indicate channel quality of wireless communications apparatus 304 to serving cell. There is a subset of channel quality indicator bits that are unused (referred to as CQI31). At substantially the same time as receiving indication 326, a CQI module 338 can set the subset of channel quality indicator bits to “1”. For example, the subset can include five unused bits and if all five bits are set to “1”, the bits correspond to decimal “31” (e.g., binary “11111” is equal to decimal “31”). The subset of CQI bits are sent to target node 308 (e.g., by a transmit component of wireless communications apparatus 304) to inform target node 308 that indication 326 has been received by wireless communications apparatus 304. In accordance with some aspects, CQI module 338 selects the subset of CQI bits from a plurality of unused channel quality indicator bits. A monitor module 340 can evaluate the bits and determine that a successful cell change occurred. In accordance with some aspects, wireless communications apparatus 304 may send the CQI31 multiple times to help ensure that the bits are received by target node 308.

In accordance with some aspects, a channel creator 342 can be configured to create a new channel (such as a Serving Cell Change Channel or SCCCH) that is sent to wireless communications apparatus 304 as the indication. SCCCH can be sent on a channelization code that is also used by an Enhanced Dedicated Channel Relative Grant Channel (E-RGCH) or an Enhanced Dedicated Channel Hybrid Automatic Repeat Request Acknowledgement Indicator Channel (E-HICH). SCCCH can be sent with a signature sequence that is different than the signature sequenced used by E-RGCH or E-HICH.

According to some aspects, a signaling module 344 is configured to utilize unused +1 on non-serving E-RGCH to indicate serving cell change to wireless communications apparatus 304. According to some aspects, signaling module 344 is configured to utilize unused −1 on non-serving E-HICH to indicate serving cell change to wireless communications apparatus 304.

System 300 can include memory 346 operatively coupled to wireless communications apparatus 304. Memory 346 can be external to wireless communications apparatus 304 or can reside within wireless communications apparatus 304. Memory 346 can store information related to sending an Event 1A message, updating an active set, transmitting an Event 1D message, receiving a target cell High Speed Shared Control Channel order, switching to a target cell, and sending an acknowledgment to target cell. In an aspect, the instructions related to receiving comprise instructions related to receiving a serving cell change channel that indicates a serving cell change. In another aspect, the instructions related to receiving comprise receiving a +1 on a non-serving Enhanced Dedicated Channel Relative Grant Channel (E-RGCH). According to a further aspect, the instructions related to receiving comprise receiving a −1 on a non-serving Enhanced Dedicated Channel Hybrid Automatic Repeat Request Acknowledgement Indicator Channel (E-HICH).

In accordance with some aspects, memory 346 retains further instructions related to toggling from a first scrambling code to a second scrambling code when switching to target cell. According to an aspect, memory 346 retains further instructions related to identifying a set of unused channel quality indicator bits, setting the set to “1” and transmitting the set as the acknowledgment. According to another aspect, memory 346 retains further instructions related to sending Event 1A message when target cell is detected and transmitting Event 1D message when a signal strength of the target cell becomes stronger than a serving cell signal strength.

At least one processor 348 can be operatively connected to wireless communications apparatus 304 (and/or memory 346) to facilitate analysis of information related to cell changes in a communication network. In accordance with some aspects, processor 348 is configured to facilitate cell changes. Processor 348 can include a first module for measuring a first pilot signal from a source node and a second pilot signal from a target node and a second module that determines second pilot signal is stronger than first pilot signal. Processor 348 can also include a third module that sends the pilot signal measurements to an entity, a fourth module that receives an indication from target node to switch to target node, and a fifth module that hands off to target node based on indication.

In accordance with some aspects, processor 348 includes a sixth module that receives a first scrambling code and a second scrambling code from entity. Also included is a seventh module that uses first scrambling code to communicate with source node before first module measures first pilot signal and second pilot signal. Also included is an eighth module that switches from first scrambling code to second scrambling code after receiving indication from target node. According to some aspects, processor 348 includes a sixth module that sets a subset of channel quality indicator bits to “1” and a seventh module that transmits the subset of channel quality indicator bits to target node in response to indication.

Additionally, system can include a memory 350 operatively coupled (internally or externally) to target node 308. Memory 350 can store information related to receiving from a RNC a radio resource control message that indicates a serving cell of a mobile device is to be changed to target node, transmitting a cell change indicator to wireless communications apparatus, and determining target node is serving wireless communications apparatus. The instructions related to sending can comprise sending a −1 on a non-serving E-HICH. The instructions related to sending can comprise sending a +1 on a non-serving E-RGCH.

In accordance with some aspects, memory 350 retains further instructions related to creating a channel to indicate a serving cell change and using the channel as the cell change indicator. According to some aspects, memory 350 retains further instructions related to sending the channel on a channelization code used by an E-RGCH or an E-HICH with a signature sequence that is different than the signature sequence of the E-RGCH or the E-HICH.

At least one processor 352 can be operatively connected to target node 308 (and/or memory 350) to facilitate analysis of information related to cell changes in a communication network. In accordance with some aspects, processor 352 is configured to facilitate cell changes. Processor 352 can include a first module that receives from a network a notification that the serving cell of wireless communications apparatus should be changed from source node to target node. Processor 352 also includes a second module that sends an indication to wireless communications apparatus that notifies wireless communications apparatus of a serving cell change and a third module that detects wireless communications apparatus handed off to target node.

In accordance with some aspects, processor 352 comprises a fourth module that receives from wireless communications apparatus a subset of unused channel quality indicator bits set to “1” and a fifth module that transmits to network a cell change complete message. According to some aspects, processor 352 comprises a fourth module that detects wireless communications apparatus has changed from a first scrambling code to a second scrambling code and a fifth module that transmits to network a cell change complete message.

Memories 346, 350 can store protocols associated with cell changes, taking action to control communication such that system 300 can employ stored protocols and/or algorithms to achieve improved communications in a wireless network as described herein. It should be appreciated that data store (e.g., memories) components described herein can be either volatile memory or nonvolatile memory, or can include both volatile and nonvolatile memory. By way of example and not limitation, nonvolatile memory can include read only memory (ROM), programmable ROM (PROM), electrically programmable ROM (EPROM), electrically erasable ROM (EEPROM), or flash memory. Volatile memory can include random access memory (RAM), which acts as external cache memory. By way of example and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Memory of the disclosed aspects are intended to comprise, without being limited to, these and other suitable types of memory.

Processors 348, 352 can be a processors dedicated to analyzing and/or generating information received, processors that control one or more components of system 300, and/or processors that both analyze and generate information received and control one or more components of system 300. Memories and/or processors can also be operatively connected to other system components (e.g., source node, RNC, and so forth).

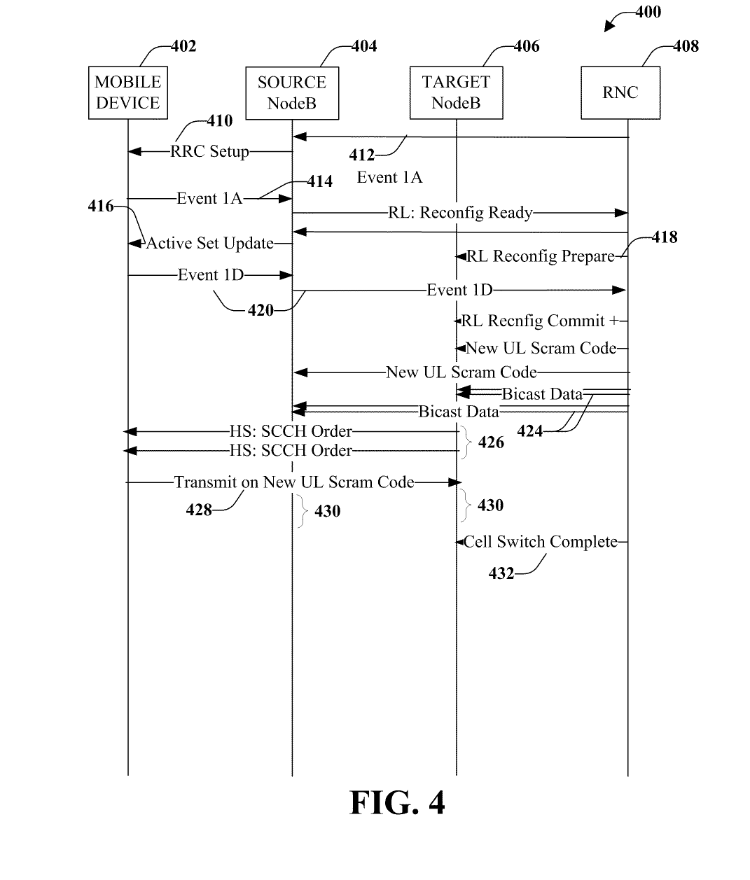

FIG. 4 illustrates a call flow 400 that can be utilized for a scrambling code change, according to an aspect. Illustrated by blocks are a mobile device 402, a source NodeB 404, a target NodeB 406, and an RNC 408. Mobile device 402 is provided two uplink scrambling codes as part of RRC Connection Setup or Cell Update Confirm 410. These scrambling codes are also provided by RNC 408 to Node Bs in mobile device's active set 412.

Mobile device sends an Event 1A 414, which is a measurement report that is configured when Target NodeB 406 has come within a certain dB of signal strength of Source NodeB 404. Mobile device 402 receives all serving cell related information (such as Serving HS-DSCH Cell Information, Enhanced Dedicated Channels (E-DCH) Reconfiguration Information) in the Active Set Update (ASU) message 416, for each cell being added to the active set. This information also includes the HS-SCCH channelization code that mobile device should monitor if a cell in the active set becomes the target cell in the serving cell change procedure.

It should be noted that in some aspects additions to the ASU message allow IEs (such as Serving HS-DSCH Cell Information and E-DCH Reconfiguration Information) to be carried in the ASU message. However, in this case, mobile device should switch to the serving cell indicated in the ASU message. In accordance with an aspect, mobile device stores all the serving cell related information and applies the information when switching to the target cell.

RNC 408 also prepares the new cell being added to the Active Set using the NodeB Application Part (NBAP) message Radio Link Reconfiguration Prepare 418. According to an aspect, changes to NBAP message include an addition of the HS-SCCH channelization code to be used for indicating serving cell change to mobile device.

After sending Event 1D 420, mobile device 402 begins monitoring HS-SCCH (on the channelization code indicated in the ASU message) for target NodeB 406. At substantially the same time as monitoring HS-SCCH, mobile device can decode data from source NodeB 404, which can minimize interruptions in voice traffic.

At about the same time as receiving Event 1D, RNC 408 instructs target NodeB 406 to indicate change of serving cell to mobile device. RNC 408 instructs all cells in the active set to begin monitoring both scrambling codes until mobile device 402 switches scrambling codes. Mobile device 402 can toggle between scrambling codes at each serving cell change. RNC 408 also starts to bicast data 424 (optional) to source NodeB 404 and target NodeB 406, which can minimize data interruption for real-time services, such as voice.

Target NodeB 406 starts sending HS-SCCH orders 426 to mobile device 402. Target NodeB HS-SCCH order is a HS-DSCH serving cell change command signaled to a mobile device by using HS-SCCH order in the target cell for which a measurement report was trigged by an Event 1D intra frequency event. At around the same time as receiving indication of serving cell change from target NodeB 406 through an HS-SCCH order, mobile device 402 changes its uplink scrambling code and transmits on the new scrambling code 428. This change in scrambling code is detected by source NodeB 404 and target NodeB 406 (as well as other NodeBs in the active set), at 430. NodeBs in mobile device's active set should monitor and compare energy on two uplink scrambling codes for a short period of time. Target NodeB 406 can start serving mobile device 402 and source NodeB 404 can stop serving mobile device 402 after mobile device transmits on the new scrambling code. Target NodeB 406 informs RNC 408 of the successful change in serving cell 432. Upon receiving the information, RNC 408 stops bicasting data.

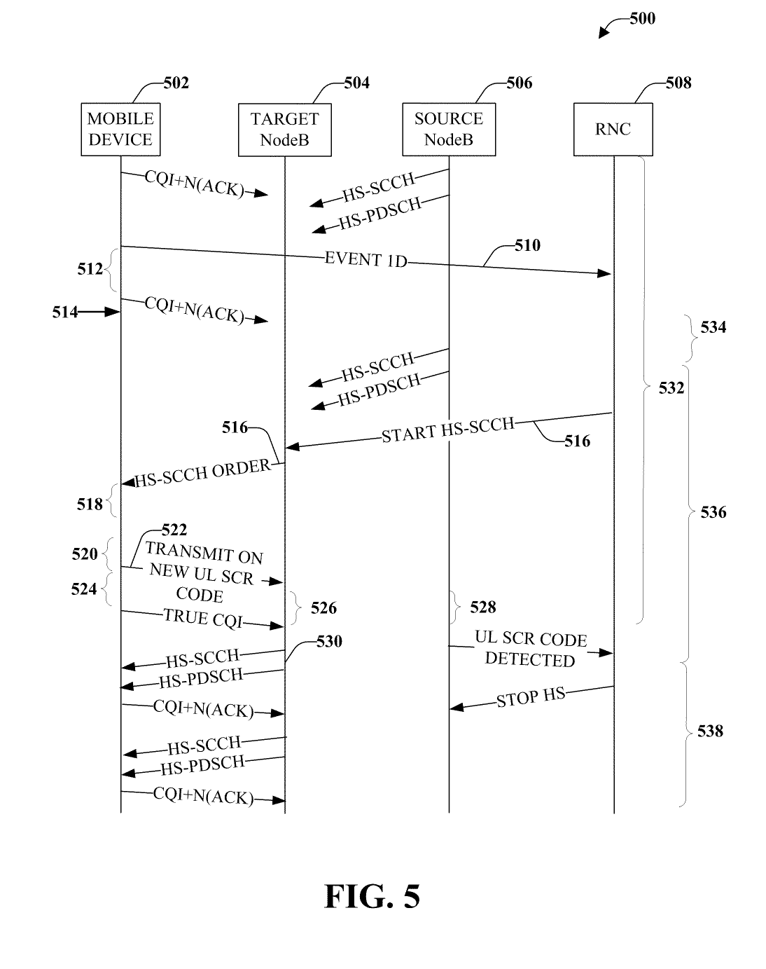

FIG. 5 illustrates a flow diagram 500 of a modified Fast Serving Cell procedure based on uplink scrambling codes, according to an aspect. Represented by boxes are a mobile device 502, a target NodeB 504, a source Node B 506, and a RNC 508. As illustrated, source NodeB 506 transmits HS-SCCH and HS-PDSCH (High-Speed Physical Downlink Shared Channel) and mobile device 502 transmits CQI and acknowledgements (ACK) or negative acknowledgements (NAK), illustrated as “CQI+N(ACK)”.

RNC 508 provides mobile device 502 two uplink scrambling codes as part of CELL UPDATE CONFIRM and RRC Connection Setup messages. Mobile device 502 transmits on Uplink Scrambling Code 1. Mobile device 502 transmits Event 1D 510. Mobile device 502 monitors HS-SCCH from both serving cell (e.g., source NodeB 506) and target cell (target NodeB 504). Mobile device HS-SCCH reconfiguration time is illustrated, at 512. Mobile device 502 begins monitoring source and target HS-SCCH at 514.

RNC 508 communicates Uplink Scrambling Code 2 to all cells in active set of mobile device 502. This triggers all the cells in active set of mobile device 502 to monitor signal strength on Uplink Scrambling Code 2, in addition to Uplink Scrambling Code 1. Mobile device 502 receives HS-SCCH order 516 from target NodeB 504. Mobile device HS-DSCH reconfigure time is illustrated, at 518. Mobile device 502 monitors target HS-SCCH only, at 520. HS-SCCH order 516 indicates to mobile device 502 to physically reconfigure to the target NodeB 504 cell.

When mobile device 502 reconfigures to target NodeB 504 cell, mobile device 502 transmits on Uplink Scrambling Code 2, illustrated at 522. Target NodeB 504 detects a loss in signal strength on Uplink Scrambling Code 1 and a gain in signal strength on Uplink Scrambling Code 2. These changes in signal strength serve as an indication to target NodeB 504 that mobile device 502 has re-configured to target NodeB 504 and is ready to receive HS data from target NodeB 504 cell.

The remaining cells in active set of mobile device 502 also detect this change in signal strength. This allows the downlink schedulers in the former serving cell to stop transmitting data to mobile device 502. All the cells will also communicate the reconfiguration event to RNC 508 indicating the end of the fast serving cell change procedure.

In accordance with some aspects, a delay (or wait) for Nsync ms occurs, at 524 to allow for mobile device 502 scrambling code detection at all NodeBs in active set before sending True CQI and data on the uplink. Uplink scrambling code detection phase is indicated, at 526 and 528.

Upon completion of the fast serving cell change procedure, mobile device 502 could also send an L3 Reconfiguration Complete message back to RNC 508. Target NodeB 504 then begins to send HS data to mobile device 502, wherein first transmission from Target NodeB 504 is illustrated at 530.

Data to source cell is indicated during 532. E1D processing is indicated at 534. Data to Target cell but not sent on HS-DSCH is indicated at 536. Data to Target Cell is indicated at 538.

Advantages of modifying a Fast Serving Cell procedure based on uplink scrambling codes include the capability to monitor two scrambling codes in the NodeB though RNC control is available. However, there might need to be modifications to the CELL UPDATE CONFIRM and RRC CONNECTION SETUP message to indicate the two scrambling codes and the capability to toggle scrambling codes if there was no ASU between two serving cell changes.

Another advantage is that the procedure is clean and does not have to rely on DPCCH energy measurements on the new scrambling code to detect the reconfiguration event, but also can detect the absence of energy on the old scrambling code.

A further advantage is the source cell also detects the reconfiguration event, since the serving cell is also monitoring the two codes and, therefore, can stop sending data on the HS channel about the same time as serving cell detects this event. Another advantage is that there exists a duality between downlink and uplink for a clean design. In the downlink, mobile device monitors HS-SCCH from source NodeB to target NodeB. In the uplink, the NodeB monitors two uplink scrambling codes for a short period of time (for example, up to around forty milliseconds) whenever 1D occurs.

Yet another advantage is that there is no tying to the timing requirement of the ACK/NAK channel on the HS-DPCCH. Nor is programming the mobile device to transmit a certain number of CQIs a concern. For example, CQIs and ACK were intended for a different purpose. Instead, one or more aspects can sense the event though pilot energy measurement.

Another advantage is target NodeB can potentially detect the reconfiguration event much faster than the CQI or ACK/NAK approach and, therefore, can begin scheduling this mobile device faster.

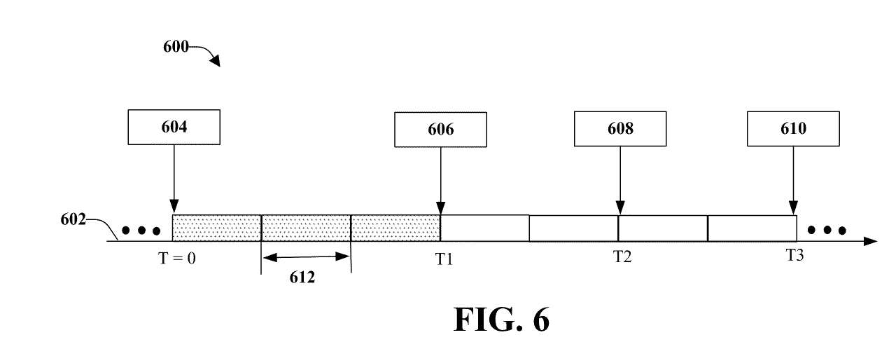

FIG. 6 illustrates a schematic representation of timing 600 of dual scrambling codes detection at Node B, according to an aspect. Time is represented along the horizontal axis 602. An assumption is that NodeB begins monitoring the two scrambling codes C1 and C2 at time 0 (604). At time T1 (606), mobile device switches to new scrambling code C2 and transmits on new scrambling code. If NodeB detects the new scrambling code at time T2 (608), then NodeB starts serving mobile device. However, if NodeB does not detect the new scrambling code until time T3 (610), NodeB stops detection and terminates the procedure.

The time T1 when mobile device switches to new scrambling code is an unknown variable to NodeB. For fast service cell change, NodeB should quickly detect the scrambling code change but not make a false alarm. Since the signal strength on the scrambling code can be used as an indication of the presence of the scrambling code, signal to interference ratio (SIR) estimates can be compared over the two scrambling codes and the ratio between them can be used as decision statistics. The method by SIR estimate is simple but can be reliable for detecting the change of scrambling codes. The procedure starts (Step 0) when some RAKE fingers are assigned to monitor both scrambling codes. Channel estimates are derived over the k-th observation window 612 using the two scrambling codes (Step 1). The noise variance is estimated (Step 2). The SIRS of the two scrambling codes is calculated (Step 3). If the ratio Rₖ=SIR_{2,k}/SIR_{1,k}>threshold, then declare the new scrambling code. Otherwise, if the time reaches T3 (610), terminate the detection process, else, move to the k+1-th observation window and go to Step 1. In accordance with some aspects, a false alarm can occur where NodeB finds new scrambling code at time T2<T1. According to another aspect a missed detection can occur where NodeB does not detect the new scrambling code at time T3 (610).

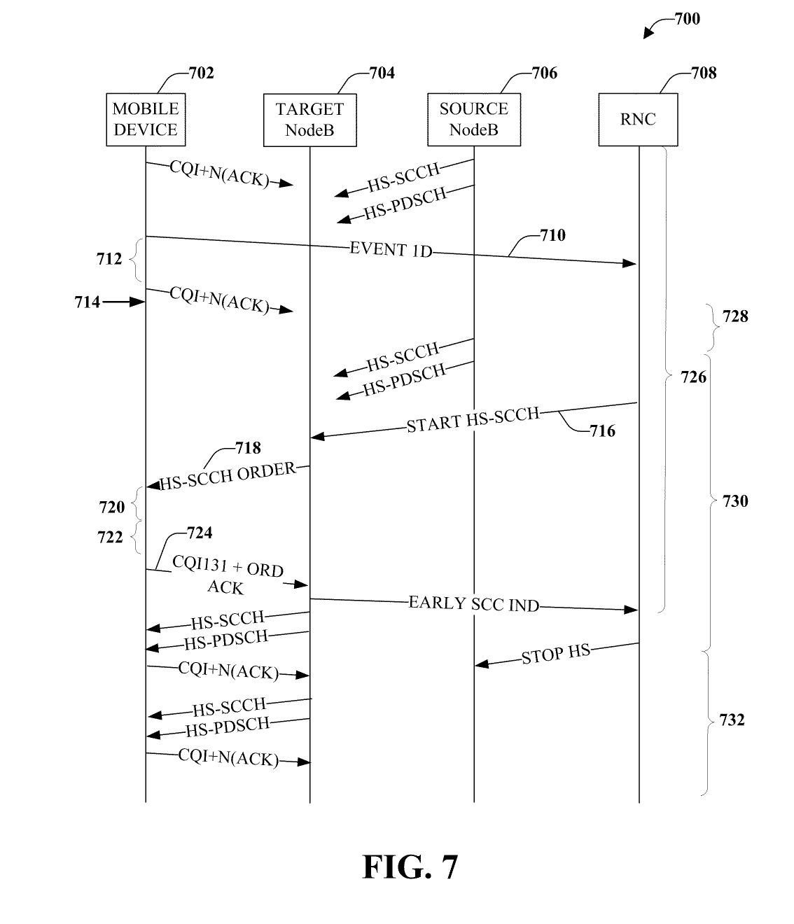

FIG. 7 illustrates a flow diagram 700 of a Fast Serving Cell (FSCC) procedure based on CQI31, according to an aspect. CQI31 is an unused value of CQI. Represented by blocks are a mobile device 702, a target NodeB 704, a source NodeB 706, and an RNC 708. Mobile device 702 can send CQI31 on the uplink to acknowledge receiving the serving cell change indication.

As illustrated, source NodeB 706 transmits HS-SCCH and HS-PDSCH and mobile device 702 transmits CQI and acknowledgements (ACK) or negative acknowledgements (NAK), illustrated as “CQI+N(ACK)”. Mobile device transmits an Event 1D 710 to RNC 708. Mobile device HS-SCCH reconfiguration time is illustrated, at 712. Mobile device monitors HS-SCCH from both serving cell (e.g., source NodeB 706) and target cell (e.g., target NodeB 704). HS-SCCH indicates to mobile device 702 to physically reconfigure to target cell (e.g., target NodeB 704). This monitoring is started, at 714.

RNC 708 starts HS-SCCH, at 716. Mobile device 702 receives HS-SCCH order 718 from target NodeB 704. HS-SCCH order 718 indicates to mobile device 702 to physically reconfigure to target NodeB 704. Another mobile device HS-DSCH reconfigure time is illustrated, at 720. During the period represented, at 722, mobile device 702 monitors target HS-SCCH only.

Mobile device 702 transmits N CQI31 724 (CQI31+ORD ACK) on the HS-DPCCH to target NodeB 704. When target NodeB 704 detects Nc CQI31, it serves as an indication to target NodeB 704 that mobile device 702 has re-configured to target NodeB 704 and that mobile device 702 is ready to receive HS data from target NodeB 704. Target NodeB 704 then begins to send HS data to mobile device 702.

Data to source cell is indicated at 726. E1D processing is indicated at 728. Data to target cell but not sent on HS-DSCH is indicated at 730. Data to target cell is indicated at 732.

One or more of the disclosed aspects modifies the CQI31 portion of the above described procedure for a number of reasons. First, in the case of MIMO, further modification to the procedure is needed to accommodate CQI31, since MIMO allows for two types of CQI messages, which are Type A and Type B. Next, modifications are needed at both mobile device 702 and target NodeB 704 to handle transmission and reception of CQI31 respectively. Further, there is still uncertainty in the mobile device 702 as to when target NodeB 704 received an adequate number of CQI31 reports. Also, when mobile device beings sending the true CQI, mobile device 702 is still unsure if target NodeB 704 is prepared to receive the true CQI.

When configured to perform MIMO, mobile device reports Type A and Type B CQIs. Type A values range from 0 to 255 and Type B values range from 0 to 30. Thus, when configured to perform MIMO, Type B CQI can be used for indicating CQI31.

Under severe link imbalance scenarios (e.g., weak link on target cell) a number of CQI31s may need to be sent to increase reliability of reception. Thus, mobile device can also send an F-SCC Complete RRC message in addition to CQI31. This message is selection combined and can help under sever link imbalance scenarios. Under sever link imbalance scenarios, the F-SCC Complete RRC message can provide more robustness of signaling. Under regular scenarios, the CQI31 signaling can allow for a quicker manner to complete serving cell change signaling.

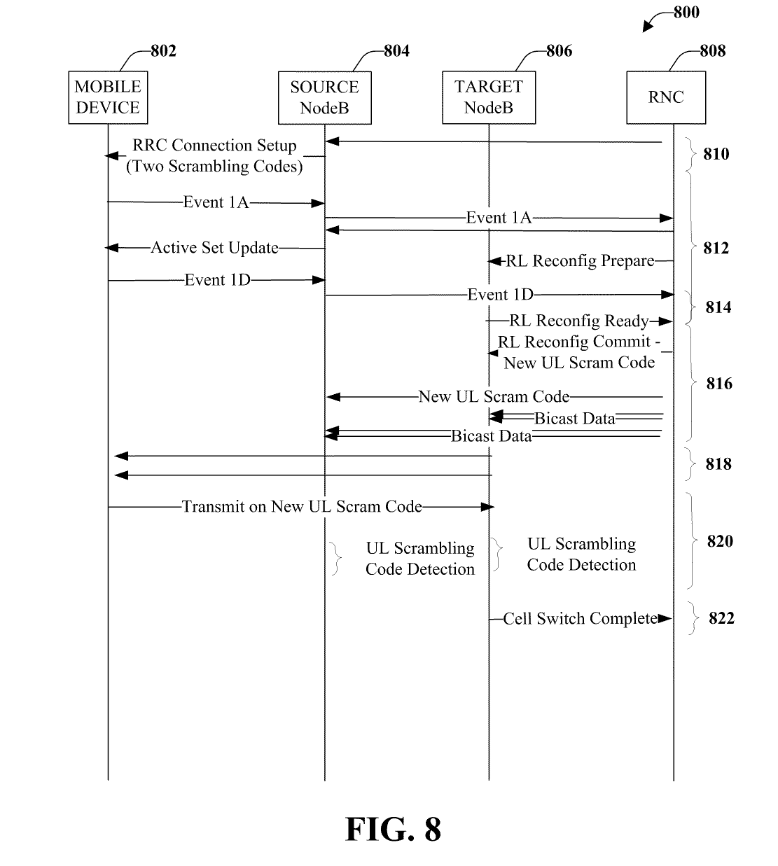

FIG. 8 illustrates a call flow 800 for indicating a serving cell change, according to an aspect. Instead of using an HS-SCCH order from target cell to indicate a serving cell change, one of at least three options can be utilized. An option includes a new channel such as a Serving Cell Change Channel or SCCCH to indicate serving cell change. The new channel can be carried in a similar manager as E-RGCH (Enhanced Dedicated Channels Relative Grant Channel) or E-HICH (Enhanced Dedicated Channels Hybrid Automatic Repeat Request Acknowledgement Indicator Channel) from the non-serving cell. For a particular mobile device, E-RGCH and E-HICH are carried on the same channelization code. The new channel, SCCCH, can be carried in the same channelization code as E-RGCH and E-HICH, but with a different signature sequence (out of the forty allowed per channelization code). A +1 and a −1 can be signaled on SCCCH bits and, therefore, two mobile devices can be assigned the same signature sequence.

Another option is to use the unused +1 on non-serving E-RGCH to indicate serving cell channel. However, E-RGCH is soft-combined from cells belonging to the same radio link set. Thus, for Intra-Node B serving cell change, using non-serving E-RGCH to indicate serving cell changes might not work. Therefore, SCCCH bits can be assigned for cells in the same radio link set as the current serving cell. For cells not in the same radio link set as the current serving cell, the unused +1 on E-RGCH can be used. In accordance with some aspects, non-serving E-HICH can be used instead of the non-serving E-RGCH, by making use of the unused −1 on non-serving E-HICH.

A further option is to restrict the serving E-DCH radio link set to only include the serving cell. Thus, even for Intra-Node B serving cell change, it is possible to use +1 on non-serving E-RGCH to signal serving cell change. Since mobile device needs to monitor only one channelization code for E-RGCH, E-HICH and SCCCH, there is minimal (if any) hardware impact.

As shown in FIG. 8, entities are shown as blocks and include a mobile device 802, a source NodeB 804, a target NodeB 806, and an RNC 808. Mobile device 802 is provided two uplink scrambling codes as part of RRC Connection Setup or Cell Update Confirm 810. These scrambling codes are also provided by RNC 808 to Node Bs in mobile device's active set.

As shown, at 812, mobile device 802 sends an Event 1A and receives all serving cell related information (such as Serving HS-DSCH Cell Information, E-DCH Reconfiguration Information) in the Active Set Update (ASU) message for each cell being added to the active set. Mobile device 802 also receives a signature sequence to be used for the SCCCH or E-RGCH on the same channelization codes as the E-HICH and E-RGCH.

RNC 808 also prepares the new cell being added to the Active Set, using the NBAP message Radio Link Reconfiguration Prepare. In accordance with an aspect, this message includes the addition of the HS-SCCH channelization code to be used for indicating serving cell change to mobile device.

After sending Event 1D, at 814, mobile device 802 monitors SCCCH or E-RGCH from the target NodeB 806 while still decoding data from source NodeB 804, which can mitigate interruptions in voice traffic.

At about the same time as receiving Event 1D, at 816, RNC 808 instructs target NodeB 806 to indicate change of serving cell to mobile device 802. RNC 808 instructs all cells in the active set to start monitoring both scrambling codes until mobile device 802 switches to the new scrambling code. RNC 808 also starts to bicast data (optional) to source NodeB 804 and target NodeB 806, which can mitigate interruption for real-time services, such as voice.

Target NodeB 806 starts indicating change of serving cell to mobile device on the SCCCH or E-RGCH, at 818.

At 820, at about the same time as receiving indication of serving cell change from target NodeB 806 through SCCCH or E-RGCH, mobile device 802 changes its uplink scrambling code. This change in scrambling code is detected by source NodeB 804 and target NodeB 806. Target NodeB 806 can now start serving mobile device 802. Source NodeB 804 stops serving mobile device 802. Target NodeB 806 informs RNC 808 of the successful change in serving cell and RNC 808 stops bicasting, at 822.

In accordance with some aspects, a computer program product can include a computer-readable medium that comprises codes for carrying out various aspects. Computer-readable medium of a mobile device can include a first set of codes for causing a computer to measure pilot signals of nodes included in an active set, wherein the active set comprises a source node and at least one target node. Computer-readable medium also includes a second set of codes for causing computer to determine from the pilot signals that a pilot signal of source node is weaker than pilot signal of at least one target node. Also included in computer-readable medium is a third set of codes for causing computer to request a handoff from source node to at least one target node and a fourth set of codes for causing computer to receive a handoff confirmation from at least one target node. Computer-readable medium also includes a fifth set of codes for causing computer to acknowledge handoff confirmation and a sixth set of codes for causing computer to handoff from source node to at least one target node.

In accordance with some aspects, computer-readable medium further comprises a seventh set of codes for causing computer to toggle from a first scrambling code to a second scrambling code and an eighth set of codes for causing computer to use second scrambling code to communicate with at least one target node. According to some aspects, computer-readable medium comprises a seventh set of codes for causing computer to activate a subset of unused channel quality indicator bits and an eighth set of codes for causing computer to transmit subset to at least one target node in response to handoff confirmation.

Computer-readable medium of a NodeB can include a first set of codes for causing a computer to receive from a radio network controller a radio resource control message that indicates a serving cell of a mobile device is to be changed to wireless communications apparatus. Computer-readable medium can also include a second set of codes for causing computer to transmit a cell change indicator to mobile device and a third set of codes for causing computer to determine wireless communications apparatus (e.g., target node) is serving the mobile device. According to some aspects, computer-readable medium comprises a fourth set of codes for causing computer to create a channel to indicate a serving cell change and using the channel as the cell change indicator. In accordance with some aspects, computer-readable medium of NodeB comprises a fifth set of codes for causing computer to send the channel on a channelization code used by an E-RGCH or an E-HICH with a signature sequence that is different than the signature sequence of the E-RGCH or the E-HICH.

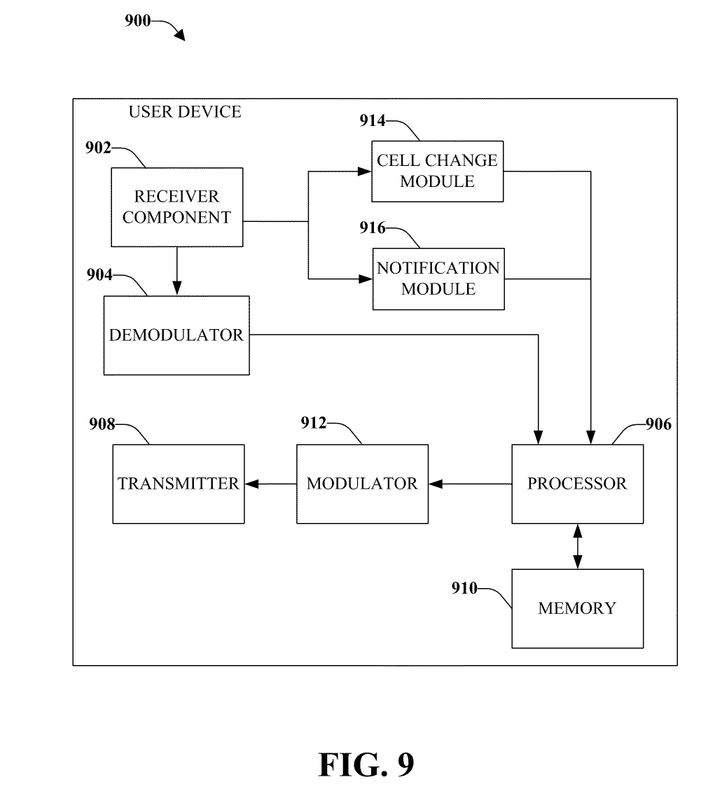

With reference now to FIG. 9, illustrated is a system 900 that facilitates cell changes in accordance with one or more of the disclosed aspects. System 900 can reside in a user device. System 900 comprises a receiver component 902 that can receive a signal from, for example, a receiver antenna. Receiver component 902 can perform typical actions thereon, such as filtering, amplifying, downconverting, etc. the received signal. Receiver component 902 can also digitize the conditioned signal to obtain samples. A demodulator 904 can obtain received symbols for each symbol period, as well as provide received symbols to a processor 906.

Processor 906 can be a processor dedicated to analyzing information received by receiver component 902 and/or generating information for transmission by a transmitter 908. In addition or alternatively, processor 906 can control one or more components of user device, analyze information received by receiver component 902, generate information for transmission by transmitter 908, and/or control one or more components of user device. Processor 906 may include a controller component capable of coordinating communications with additional user devices.

System 900 can additionally comprise memory 910 operatively coupled to processor 906. Memory 910 can store information related to coordinating communications and any other suitable information. Memory 910 can additionally store protocols associated with serving cell changes. Memory 910 of the various aspects is intended to comprise, without being limited to, these and any other suitable types of memory. System 900 can further comprise a symbol modulator 912, wherein transmitter 908 transmits the modulated signal.

Receiver component 902 is further operatively coupled to a cell change module 914 that is configured to transmit events (such as Event 1A and Event 1D) and determine if a signal strength of a target cell is stronger than a signal strength of a current serving cell. Cell change module 914 can also be configured to change from current serving cell to target cell based on an instruction received from target cell.

Additionally, receiver component 902 can be operatively coupled to a notification module 916 that is configured to acknowledge the cell change. The acknowledgement can be sent to target node. The acknowledgement can include changing from a first scrambling code to a second scrambling code and/or sending a CQI31 to target node.

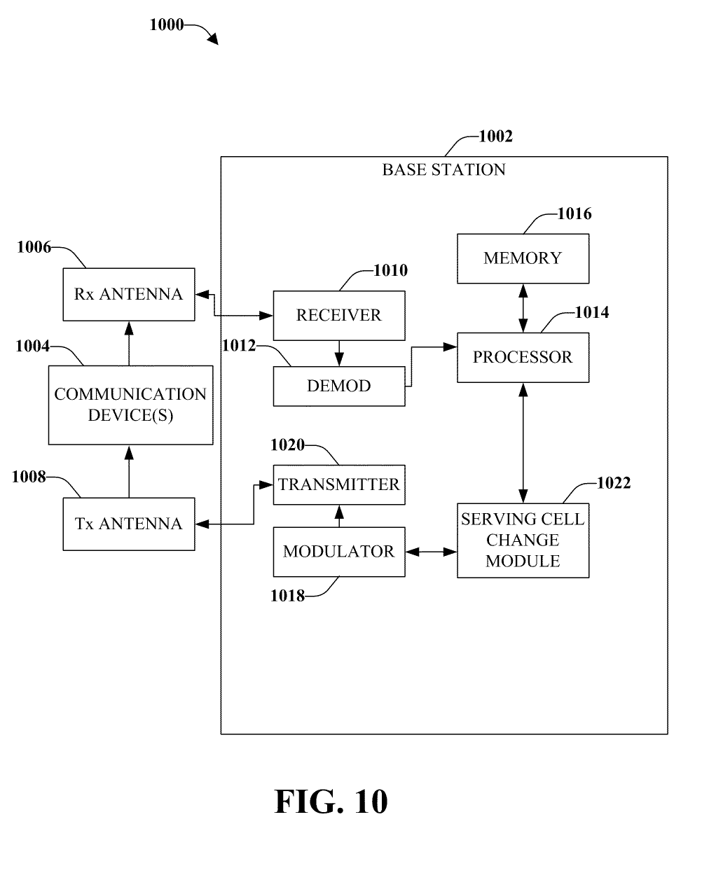

FIG. 10 is an illustration of a system 1000 that facilitates serving cell change procedures using acknowledgements in accordance with various aspects presented herein. System 1000 comprises an access point or base station 1002. As illustrated, base station 1002 receives signal(s) from one or more communication devices 1004 (e.g., user device) by a receive antenna 1006, and transmits to the one or more communication devices 1004 through a transmit antenna 1008.

Base station 1002 comprises a receiver 1010 that receives information from receive antenna 1006 and is operatively associated with a demodulator 1012 that demodulates received information. Demodulated symbols are analyzed by a processor 1014 that is coupled to a memory 1016 that stores information related to serving cell change procedures. A modulator 1018 can multiplex the signal for transmission by a transmitter 1020 through transmit antenna 1008 to communication devices 1004.

Processor 1014 is further coupled to a serving cell change module 1022 that is configured to receive an RRC message from an RNC. The RRC message instructs base station 1002 that a mobile device should be handed off to base station. Serving cell change module 1022 sends an indication to mobile device to change its serving cell and receives an acknowledgement from mobile device after successful completion of serving cell change.

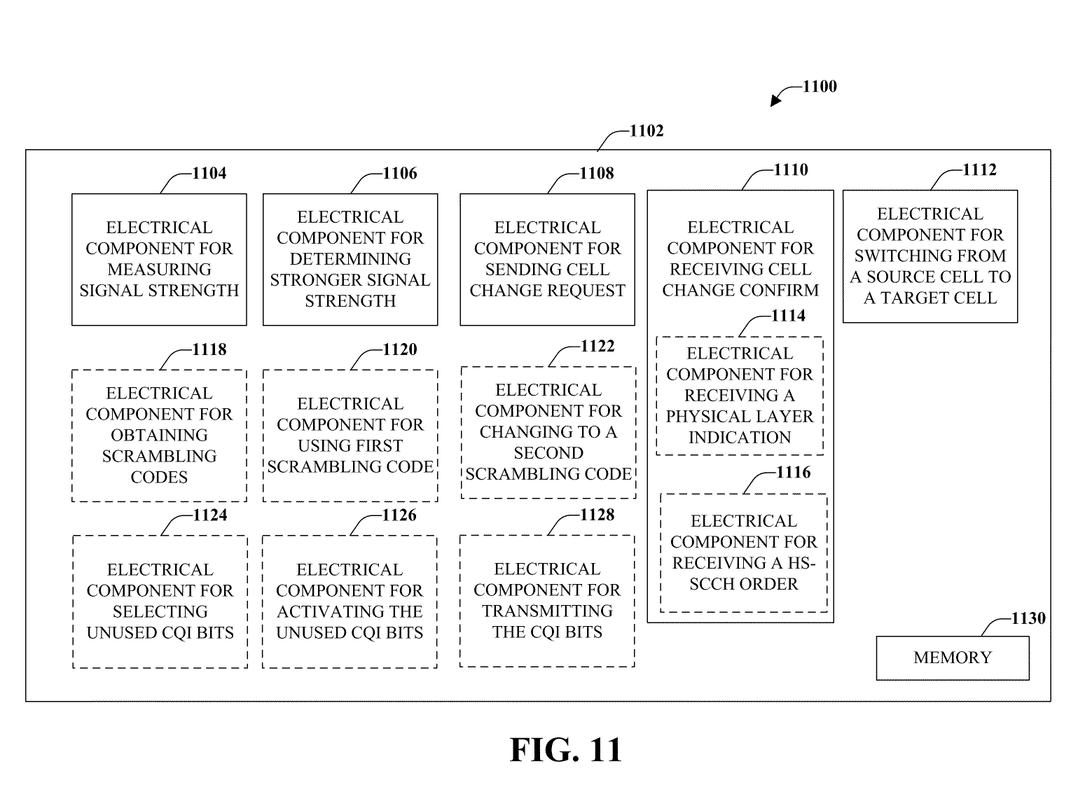

With reference to FIG. 11, illustrated is an example system 1100 that facilitates serving cell change procedures, according to an aspect. System 1100 may reside at least partially within a mobile device. It is to be appreciated that system 1100 is represented as including functional blocks, which may be functional blocks that represent functions implemented by a processor, software, or combination thereof (e.g., firmware).

System 1100 includes a logical grouping 1102 of electrical components that can act separately or in conjunction. Logical grouping 1102 may include an electrical component 1104 for measuring signal strengths of cells in an active set that comprises a serving cell and a target cell. Also included is an electrical component 1106 for determining from the signal strengths that a signal strength of serving cell is weaker than the signal strength of target cell. Logical grouping 1102 also includes an electrical component 1108 for sending a cell change request and an electrical component 1110 for receiving a cell change confirm from the target cell. Logical grouping 1102 also includes an electrical component 1112 for switching from the serving cell to the target cell.

According to some aspects, electrical component 1110 includes an electrical component 1114 for receiving a physical layer indication from the target cell. According to other aspects, electrical component 1110 includes an electrical component 1116 for receiving a High Speed Shared Control Channel order.

In accordance with some aspects, logical grouping 1102 includes an electrical component 1118 for obtaining a first scrambling code and a second scrambling code during a setup procedure and an electrical component 1120 for using the first scrambling code to communicate with the serving cell. Also included is an electrical component 1122 for changing from the first scrambling code to the second scrambling code after electrical component 1110 receives the cell change confirm.

According to some aspects, logical grouping 1102 includes an electrical component 1124 for selecting a subset of unused channel quality indicator bits and an electrical component 1126 for activating the subset (e.g., setting the bits to “1”). Also included is an electrical component 1128 for transmitting the subset to the target cell in response to the cell change confirm.

Additionally, system 1100 can include a memory 1130 that retains instructions for executing functions associated with electrical components 1104-1128 or other components. While shown as being external to memory 1130, it is to be understood that one or more of electrical components 1104-1128 may exist within memory 1130.

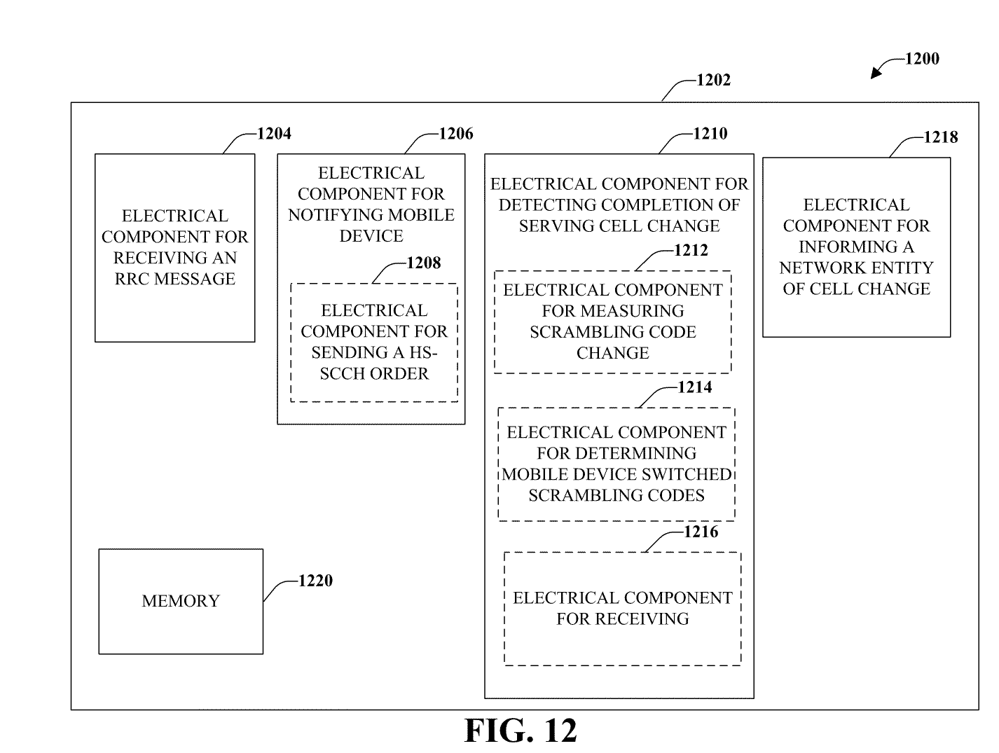

With reference to FIG. 12, illustrated is an example system 1200 that is configured for HS-DSCH serving cell change procedures in UMTS, according to an aspect. System 1200 may reside at least partially within a NodeB. System 1200 is represented as including functional blocks, which may be functional blocks that represent functions implemented by a processor, software, or combination thereof (e.g., firmware).

System 1200 includes a logical grouping 1202 of electrical components that can act separately or in conjunction. Logical grouping 1202 may include an electrical component 1204 for receiving an indication that a serving cell of a mobile device is to be changed to NodeB. The indication can be received in an RRC message. Also include is an electrical component 1206 for notifying mobile device of the serving cell change. In accordance with some aspects, electrical component 1206 includes an electrical component 1208 for sending a High Speed Shared Control Channel (HS-SCCH) order to mobile device.

Logical grouping 1202 also includes an electrical component 1210 for detecting a completion of the serving cell change. According to some aspects, electrical component 1210 includes an electrical component 1212 for measuring a change from a first scrambling code to a second scrambling code and an electrical component 1214 for determining the mobile device has switched from first scrambling code to second scrambling code. In accordance with some aspects, electrical component 1212 includes an electrical component 1216 for receiving from mobile device a subset of unused channel quality indicators bits set to “1” and/or ACK bits.

Also included in logical grouping 1202 is an electrical component 1218 for informing a network entity of the completion (e.g., successful completion of handoff to target node). The network entity can be an RNC or another node.

Additionally, system 1200 can include a memory 1220 that retains instructions for executing functions associated with electrical components 1204-1218 or other components. While shown as being external to memory 1220, it is to be understood that one or more of electrical components 1204-1218 may exist within memory 1220.

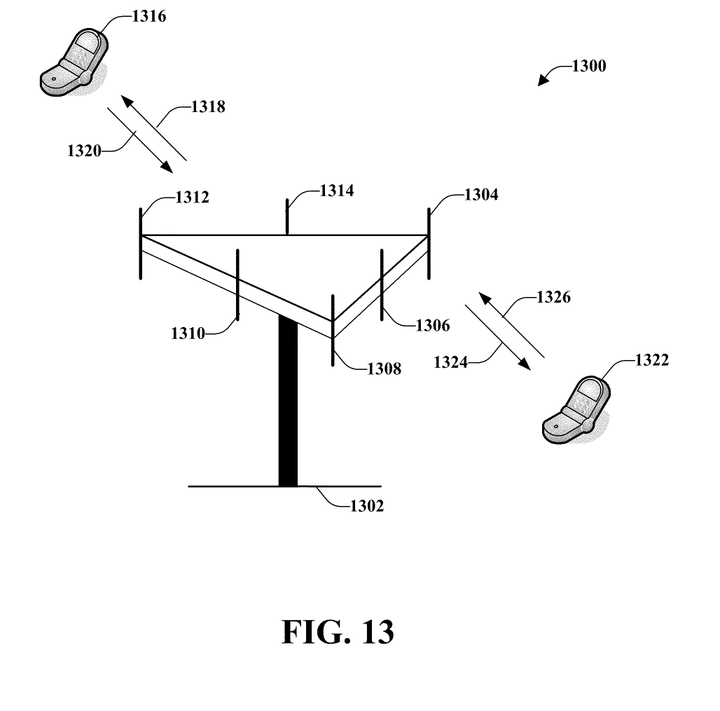

Referring now to FIG. 13, a multiple access wireless communication system 1300 according to one or more aspects is illustrated. A wireless communication system 1300 can include one or more base stations in contact with one or more user devices. Each base station provides coverage for a plurality of sectors. A three-sector base station 1302 is illustrated that includes multiple antenna groups, one including antennas 1304 and 1306, another including antennas 1308 and 1310, and a third including antennas 1312 and 1314. According to the figure, only two antennas are shown for each antenna group, however, more or fewer antennas may be utilized for each antenna group. Mobile device 1316 is in communication with antennas 1312 and 1314, where antennas 1312 and 1314 transmit information to mobile device 1316 over forward link 1318 and receive information from mobile device 1316 over reverse link 1320. Forward link (or downlink) refers to communication link from base stations to mobile devices, and reverse link (or uplink) refers to communication link from mobile devices to base stations. Mobile device 1322 is in communication with antennas 1304 and 1306, where antennas 1304 and 1306 transmit information to mobile device 1322 over forward link 1324 and receive information from mobile device 1322 over reverse link 1326. In a FDD system, for example, communication links 1318, 1320, 1324, and 1326 might utilize different frequencies for communication. For example, forward link 1318 might use a different frequency than the frequency utilized by reverse link 1320.

Each group of antennas and/or the area in which they are designated to communicate may be referred to as a sector of base station 1302. In one or more aspects, antenna groups each are designed to communicate to mobile devices in a sector or the areas covered by base station 1302. A base station may be a fixed station used for communicating with mobile devices.

In communication over forward links 1318 and 1324, transmitting antennas of base station 1302 can utilize beamforming in order to improve a signal-to-noise ratio of forward links for different mobile devices 1316 and 1322. Also, a base station utilizing beamforming to transmit to mobile devices scattered randomly through its coverage area might cause less interference to mobile devices in neighboring cells than the interference that can be caused by a base station transmitting through a single antenna to all mobile devices in its coverage area.

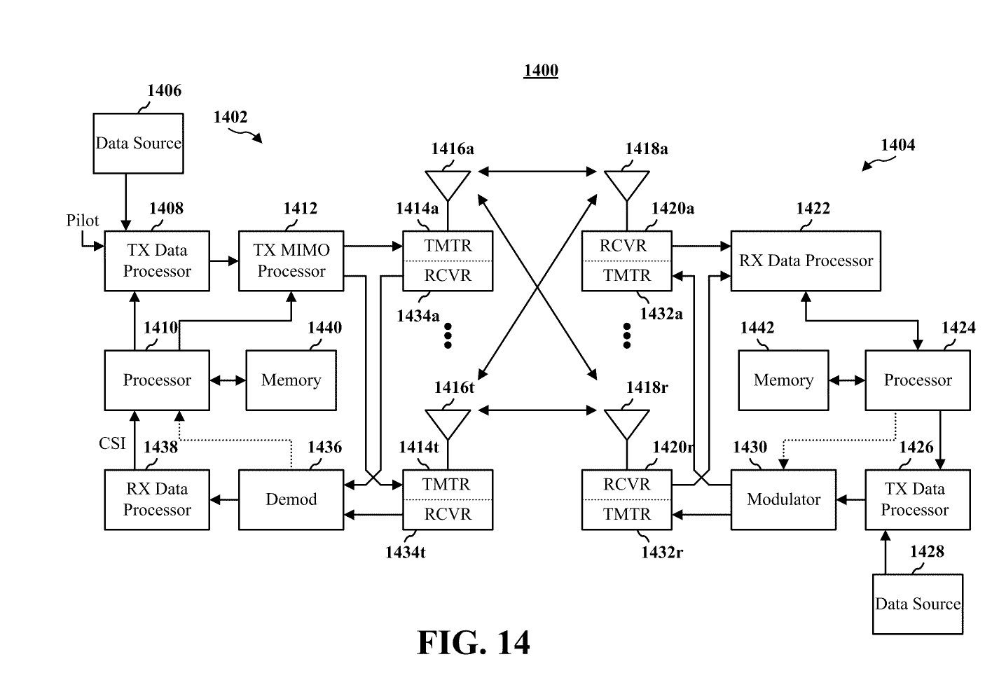

FIG. 14 illustrates an example wireless communication system 1400. The wireless communication system 1400 depicts one base station 1402 and one mobile device 1404 for sake of brevity. However, it is to be appreciated that wireless communication system 1400 can include more than one base station and/or more than one mobile device, wherein additional base stations and/or mobile devices can be substantially similar or different from example base station 1402 and mobile device 1404 described below. In addition, it is to be appreciated that base station 1402 and/or mobile device 1404 can employ the systems and/or methods described herein to facilitate wireless communication there between.

At base station 1402, traffic data for a number of data streams is provided from a data source 1406 to a transmit (TX) data processor 1408. According to an example, each data stream can be transmitted over a respective antenna. TX data processor 1408 formats, codes, and interleaves the traffic data stream based on a particular coding scheme selected for that data stream to provide coded data.

The coded data for each data stream can be multiplexed with pilot data using orthogonal frequency division multiplexing (OFDM) techniques. Additionally or alternatively, the pilot symbols can be frequency division multiplexed (FDM), time division multiplexed (TDM), or code division multiplexed (CDM). The pilot data is typically a known data pattern that is processed in a known manner and can be used at mobile device 1404 to estimate channel response. The multiplexed pilot and coded data for each data stream can be modulated (e.g., symbol mapped) based on a particular modulation scheme (e.g., binary phase-shift keying (BPSK), quadrature phase-shift keying (QPSK), M-phase-shift keying (M-PSK), M-quadrature amplitude modulation (M-QAM), etc.) selected for that data stream to provide modulation symbols. The data rate, coding, and modulation for each data stream can be determined by instructions performed or provided by processor 1410.

The modulation symbols for the data streams can be provided to a TX MIMO processor 1412, which can further process the modulation symbols (e.g., for OFDM). TX MIMO processor 1412 then provides N_{T} modulation symbol streams to N_{T} transmitters (TMTR) 1414a through 1414t. In various embodiments, TX MIMO processor 1412 applies beamforming weights to the symbols of the data streams and to the antenna from which the symbol is being transmitted.

Each transmitter 1414 receives and processes a respective symbol stream to provide one or more analog signals, and further conditions (e.g., amplifies, filters, and upconverts) the analog signals to provide a modulated signal suitable for transmission over the MIMO channel. Further, N_{T} modulated signals from transmitters 1414a through 1414t are transmitted from N_{T} antennas 1416a through 1416t, respectively.

At mobile device 1404, the transmitted modulated signals are received by N_{R} antennas 1418a through 1418r and the received signal from each antenna 1418 is provided to a respective receiver (RCVR) 1420a through 1420r. Each receiver 1420 conditions (e.g., filters, amplifies, and downconverts) a respective signal, digitizes the conditioned signal to provide samples, and further processes the samples to provide a corresponding “received” symbol stream.

An RX data processor 1422 can receive and process the N_{R} received symbol streams from N_{R} receivers 1420 based on a particular receiver processing technique to provide N_{T} “detected” symbol streams. RX data processor 1422 can demodulate, deinterleave, and decode each detected symbol stream to recover the traffic data for the data stream. The processing by RX data processor 1422 is complementary to that performed by TX MIMO processor 1412 and TX data processor 1408 at base station 1402.

A processor 1424 can periodically determine which precoding matrix to utilize as discussed above. Further, processor 1424 can formulate a reverse link message comprising a matrix index portion and a rank value portion.

The reverse link message can comprise various types of information regarding the communication link and/or the received data stream. The reverse link message can be processed by a TX data processor 1426, which also receives traffic data for a number of data streams from a data source 1428, modulated by a modulator 1430, conditioned by transmitters 1432a through 1432r, and transmitted back to base station 1402.

At base station 1402, the modulated signals from mobile device 1404 are received by antennas 1416, conditioned by receivers 1434a though 1434t, demodulated by a demodulator 1436, and processed by a RX data processor 1438 to extract the reverse link message transmitted by mobile device 1404. Further, processor 1410 can process the extracted message to determine which precoding matrix to use for determining the beamforming weights.

Processors 1410 and 1424 can direct (e.g., control, coordinate, manage, etc.) operation at base station 1402 and mobile device 1404, respectively. Respective processors 1410 and 1424 can be associated with memory 1440 and 1442 that store program codes and data. Processors 1410 and 1424 can also perform computations to derive frequency and impulse response estimates for the uplink and downlink, respectively.

In view of exemplary systems shown and described herein, methodologies that may be implemented in accordance with the disclosed subject matter, can be better appreciated with reference to the various call flows, flow diagrams, or flow charts. It is to be appreciated that functionality associated with call flows may be implemented by software, hardware, a combination thereof or any other suitable means (e.g. device, system, process, component). Additionally, it should be further appreciated that methodologies disclosed throughout this specification are capable of being stored on an article of manufacture to facilitate transporting and transferring such methodologies to various devices. Those skilled in the art will understand and appreciate that a methodology could alternatively be represented as a series of interrelated states or events, such as in a state diagram.

It is to be understood that the embodiments described herein can be implemented in hardware, software, firmware, middleware, microcode, or any combination thereof. For a hardware implementation, the processing units can be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof.

When the embodiments are implemented in software, firmware, middleware or microcode, program code or code segments, they can be stored in a machine-readable medium, such as a storage component. A code segment can represent a procedure, a function, a subprogram, a program, a routine, a subroutine, a module, a software package, a class, or any combination of instructions, data structures, or program statements. A code segment can be coupled to another code segment or a hardware circuit by passing and/or receiving information, data, arguments, parameters, or memory contents. Information, arguments, parameters, data, etc. can be passed, forwarded, or transmitted using any suitable means including memory sharing, message passing, token passing, network transmission, etc.

It is to be understood that aspects described herein may be implemented by hardware, software, firmware or any combination thereof. When implemented in software, functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if software is transmitted from a website, server, or other remote source using a coaxial cable, fiber optic cable, twisted pair, digital subscriber line (DSL), or wireless technologies such as infrared, radio, and microwave, then coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

Various illustrative logics, logical blocks, modules, and circuits described in connection with aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform functions described herein. A general-purpose processor may be a microprocessor, but, in the alternative, processor may be any conventional processor, controller, microcontroller, or state machine. A processor may also be implemented as a combination of computing devices, for example, a combination of a DSP and a microprocessor, a plurality of microprocessors, one or more microprocessors in conjunction with a DSP core, or any other such configuration. Additionally, at least one processor may comprise one or more modules operable to perform one or more of the steps and/or actions described herein.

For a software implementation, techniques described herein may be implemented with modules (e.g., procedures, functions, and so on) that perform functions described herein. Software codes may be stored in memory units and executed by processors. Memory unit may be implemented within processor or external to processor, in which case memory unit can be communicatively coupled to processor through various means as is known in the art. Further, at least one processor may include one or more modules operable to perform functions described herein.

Techniques described herein may be used for various wireless communication systems such as CDMA, TDMA, FDMA, OFDMA, SC-FDMA and other systems. The terms “system” and “network” are often used interchangeably. A CDMA system may implement a radio technology such as Universal Terrestrial Radio Access (UTRA), CDMA2000, etc. UTRA includes Wideband-CDMA (W-CDMA) and other variants of CDMA. Further, CDMA2000 covers IS-2000, IS-95 and IS-856 standards. A TDMA system may implement a radio technology such as Global System for Mobile Communications (GSM). An OFDMA system may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM®, etc. UTRA and E-UTRA are part of Universal Mobile Telecommunication System (UMTS). 3GPP Long Term Evolution (LTE) is a release of UMTS that uses E-UTRA, which employs OFDMA on downlink and SC-FDMA on uplink. UTRA, E-UTRA, UMTS, LTE and GSM are described in documents from an organization named “3rd Generation Partnership Project” (3GPP). Additionally, CDMA2000 and UMB are described in documents from an organization named “3rd Generation Partnership Project 2” (3GPP2). Further, such wireless communication systems may additionally include peer-to-peer (e.g., mobile-to-mobile) ad hoc network systems often using unpaired unlicensed spectrums, 802.xx wireless LAN, BLUETOOTH and any other short- or long-range, wireless communication techniques.

Single carrier frequency division multiple access (SC-FDMA), which utilizes single carrier modulation and frequency domain equalization is a technique that can be utilized with the disclosed aspects. SC-FDMA has similar performance and essentially a similar overall complexity as those of OFDMA system. SC-FDMA signal has lower peak-to-average power ratio (PAPR) because of its inherent single carrier structure. SC-FDMA can be utilized in uplink communications where lower PAPR can benefit a mobile terminal in terms of transmit power efficiency.

Moreover, various aspects or features described herein may be implemented as a method, apparatus, or article of manufacture using standard programming and/or engineering techniques. The term “article of manufacture” as used herein is intended to encompass a computer program accessible from any computer-readable device, carrier, or media. For example, computer-readable media can include but are not limited to magnetic storage devices (e.g., hard disk, floppy disk, magnetic strips, etc.), optical disks (e.g., compact disk (CD), digital versatile disk (DVD), etc.), smart cards, and flash memory devices (e.g., EPROM, card, stick, key drive, etc.). Additionally, various storage media described herein can represent one or more devices and/or other machine-readable media for storing information. The term “machine-readable medium” can include, without being limited to, wireless channels and various other media capable of storing, containing, and/or carrying instruction(s) and/or data. Additionally, a computer program product may include a computer readable medium having one or more instructions or codes operable to cause a computer to perform functions described herein.

Further, the steps and/or actions of a method or algorithm described in connection with aspects disclosed herein may be embodied directly in hardware, in a software module executed by a processor, or a combination thereof. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to processor, such that processor can read information from, and write information to, storage medium. In the alternative, storage medium may be integral to processor. Further, in some aspects, processor and storage medium may reside in an ASIC. Additionally, ASIC may reside in a user terminal. In the alternative, processor and storage medium may reside as discrete components in a user terminal. Additionally, in some aspects, the steps and/or actions of a method or algorithm may reside as one or any combination or set of codes and/or instructions on a machine readable medium and/or computer readable medium, which may be incorporated into a computer program product.

While the foregoing disclosure discusses illustrative aspects and/or embodiments, it should be noted that various changes and modifications could be made herein without departing from the scope of described aspects and/or embodiments as defined by the appended claims. Accordingly, described aspects are intended to embrace all such alterations, modifications and variations that fall within scope of appended claims. Furthermore, although elements of described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise.

To the extent that the term “includes” is used in either the detailed description or the claims, such term is intended to be inclusive in a manner similar to the term “comprising” as “comprising” is interpreted when employed as a transitional word in a claim. Furthermore, the term “or” as used in either the detailed description or the claims is intended to mean an inclusive “or” rather than an exclusive “or”. That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

As used in this application, the terms “component”, “module”, “system”, and the like are intended to refer to a computer-related entity, either hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. Components may communicate by way of local and/or remote processes such as in accordance with a signal having one or more data packets (e.g., data from one component interacting with another component in a local system, distributed system, and/or across a network such as the Internet with other systems by way of the signal).

Furthermore, various aspects are described herein in connection with a mobile device. A mobile device can also be called, and may contain some or all of the functionality of a system, subscriber unit, subscriber station, mobile station, mobile, wireless terminal, node, device, remote station, remote terminal, access terminal, user terminal, terminal, wireless communication device, wireless communication apparatus, user agent, user device, or user equipment (UE), and the like. A mobile device can be a cellular telephone, a cordless telephone, a Session Initiation Protocol (SIP) phone, a smart phone, a wireless local loop (WLL) station, a personal digital assistant (PDA), a laptop, a handheld communication device, a handheld computing device, a satellite radio, a wireless modem card and/or another processing device for communicating over a wireless system. Moreover, various aspects are described herein in connection with a base station. A base station may be utilized for communicating with wireless terminal(s) and can also be called, and may contain some or all of the functionality of, an access point, node, Node B, e-NodeB, e-NB, or some other network entity.

Various aspects or features will be presented in terms of systems that may include a number of devices, components, modules, and the like. It is to be understood and appreciated that various systems may include additional devices, components, modules, and so forth, and/or may not include all devices, components, modules, and so on, discussed in connection with the figures. A combination of these approaches may also be used.

Additionally, in the subject description, the word “exemplary” (and variants thereof) is used to mean serving as an example, instance, or illustration. Any aspect or design described herein as “exemplary” is not necessarily to be construed as preferred or advantageous over other aspects or designs. Rather, use of the word “exemplary” is intended to present concepts in a concrete manner.

What is claimed is:

1. A method for a serving cell change, comprising:
measuring a first pilot signal from a source node and a second pilot signal from a target node;
determining the second pilot signal is stronger than the first pilot signal;
sending measurements of the first pilot signal and the second pilot signal to an entity;
receiving an indication from the target node to switch to the target node; and
handing off to the target node based on the indication.

2. The method of claim 1, wherein the receiving includes receiving a physical layer indication from the target node.

3. The method of claim 1, further comprising:
receiving a first scrambling code and a second scrambling code from the entity;
using the first scrambling code to communicate with the source node prior to the measuring; and
switching from the first scrambling code to the second scrambling code after receiving the indication from the target node.

4. The method of claim 1, further comprising:
setting a subset of channel quality indicator bits to “1”; and
transmitting the subset of channel quality indicator bits, Acknowledgement (ACK) bits, or both the subset of channel quality indicator bits and ACK bits, to the target node in response to the indication.

5. The method of claim 4, wherein the setting comprises selecting the subset of channel quality indicator bits from a plurality of unused channel quality indicator bits.

6. The method of claim 1, wherein the receiving comprises receiving an order on a High Speed Shared Control Channel (HS-SCCH) that indicates the serving cell change.

7. The method of claim 1, wherein the receiving comprises receiving a serving cell change channel that indicates the serving cell change.

8. The method of claim 1, wherein the receiving comprises receiving a +1 on a non-serving Enhanced Dedicated Channel Relative Grant Channel (E-RGCH).

9. The method of claim 1, wherein the receiving comprises receiving a −1 on a non-serving Enhanced Dedicated Channel Hybrid Automatic Repeat Request Acknowledgement Indicator Channel (E-HICH).

10. A wireless communications apparatus, comprising:
a memory that retains instructions related to measuring a first pilot signal from a source node and a second pilot signal from a target node, determining the second pilot signal is stronger than the first pilot signal, sending measurements of the first pilot signal and the second pilot signal to an entity, receiving an indication from the target node to switch to the target node, and handing off to the target node based on the indication and
a processor, coupled to the memory, configured to execute the instructions retained in the memory.

11. The wireless communications apparatus of claim 10, the memory retains further instructions related to toggling from a first scrambling code to a second scrambling code to handoff to the target node.

12. The wireless communications apparatus of claim 10, the memory retains further instructions related to identifying a set of unused channel quality indicator bits, setting the set of unused channel quality indicator bits to “1”, and transmitting the set of unused channel quality indicator bits as an acknowledgment.

13. The wireless communications apparatus of claim 10, wherein the instructions related to receiving comprise receiving a serving cell change channel that indicates a serving cell change.

14. The wireless communications apparatus of claim 10, wherein the instructions related to receiving comprise receiving a +1 on a non-serving E-RGCH.

15. The wireless communications apparatus of claim 10, wherein the instructions related to receiving comprise receiving a −1 on a non-serving E-HICH.

16. A wireless communications apparatus that facilitates changes to a serving cell, comprising:
means for measuring signal strengths of cells in an active set that comprises the serving cell and a target cell;
means for determining from the signal strengths that a first signal strength of the serving cell is weaker than a second signal strength of the target cell;
means for sending a cell change request;
means for receiving a cell change confirm from the target cell; and
means for switching from the serving cell to the target cell.

17. The wireless communications apparatus of claim 16, further comprising:
means for obtaining a first scrambling code and a second scrambling code during a setup procedure;
means for using the first scrambling code to communicate with the serving cell; and
means for changing from the first scrambling code to the second scrambling code after the means for receiving receives the cell change confirm.

18. The wireless communications apparatus of claim 16, further comprising:
means for selecting a subset of unused channel quality indicator bits;
means for activating the subset of unused channel quality indicator bits; and
means for transmitting the subset of unused channel quality indicator bits to the target cell in response to the cell change confirm.

19. The wireless communications apparatus of claim 16, wherein the means for receiving comprises means for receiving a physical layer indication from the target cell.

20. The wireless communications apparatus of claim 16, wherein the means for receiving comprises a means for receiving a High Speed Shared Control Channel order.

21. A computer program product, comprising:
a computer-readable medium comprising:
a first set of codes for causing a computer to measure pilot signals of nodes included in an active set, wherein the active set comprises a source node and at least one target node;
a second set of codes for causing the computer to determine from the pilot signals that a pilot signal of the source node is weaker than at least one pilot signal of the at least one target node;
a third set of codes for causing the computer to request a handoff from the source node to the at least one target node;
a fourth set of codes for causing the computer to receive a handoff confirmation from the at least one target node;
a fifth set of codes for causing the computer to acknowledge the handoff confirmation; and
a sixth set of codes for causing the computer to handoff from the source node to the at least one target node.

22. The computer program product of claim 21, the computer-readable medium further comprising:
a seventh set of codes for causing the computer to toggle from a first scrambling code to a second scrambling code; and
an eighth set of codes for causing the computer to use the second scrambling code to communicate with the at least one target node.

23. The computer program product of claim 21, the computer-readable medium further comprising:
a seventh set of codes for causing the computer to activate a subset of unused channel quality indicator bits; and
an eighth set of codes for causing the computer to transmit the subset of unused channel quality indicator bits to the at least one target node in response to the handoff confirmation.

24. At least one processor configured to facilitate a serving cell change, comprising:
a first module for measuring a first pilot signal from a source node and a second pilot signal from a target node;
a second module that determines the second pilot signal is stronger than the first pilot signal;
a third module that sends measurements of the first pilot signal and the second pilot signal to an entity;
a fourth module that receives an indication from the target node to switch to the target node; and
a fifth module that hands off to the target node based on the indication.

25. The at least one processor of claim 24, further comprising:
a sixth module that receives a first scrambling code and a second scrambling code from the entity;
a seventh module that uses the first scrambling code to communicate with the source node before the first module measures the first pilot signal and the second pilot signal; and
an eighth module that switches from the first scrambling code to the second scrambling code after the fourth module receives the indication.

26. The at least one processor of claim 24, further comprising:
a sixth module that sets a subset of channel quality indicator bits to “1”; and
a seventh module that transmits the subset of channel quality indicator bits, acknowledgement (ACK) bits, or both the subset of channel quality indicator bits and the ACK bits, to the target node in response to the indication.

27. A method performed by a target node for a serving cell change, comprising:
receiving from a network a notification that a serving cell of a mobile device is to change from a source node to the target node;
sending an indication to the mobile device that notifies the mobile device of the serving cell change; and
detecting the mobile device handed off to the target node.

28. The method of claim 27, wherein the sending comprises creating a channel to indicate the serving cell change and sending the channel with the indication.

29. The method of claim 28, further comprising sending the channel on a channelization code used by an Enhanced Dedicated Channel Relative Grant Channel (E-RGCH) or an Enhanced Dedicated Channel Hybrid Automatic Repeat Request Acknowledgement Indicator Channel (E-HICH) with a signature sequence that is different than the signature sequence used by the E-RGCH or the E-HICH.

30. The method of claim 27, wherein the sending comprises sending a +1 on a non-serving E-RGCH.

31. The method of claim 27, wherein the sending comprises sending a −1 on a non-serving E-HICH.

32. The method of claim 27, wherein the detecting further comprising:
detecting the mobile device changed from a first scrambling code to a second scrambling code; and
transmitting to the network a cell change complete message.

33. The method of claim 27, wherein the detecting further comprising:
receiving from the mobile device a subset of channel quality indicator bits that are set to “1”, acknowledgement (ACK) bits, or both the subset of channel quality indicator bits and the ACK bits; and
transmitting to the network a cell change complete message.

34. A wireless communications apparatus, comprising:
a memory that retains instructions related to receiving from a radio network controller a radio resource control message that indicates a serving cell of a mobile device is to be changed to the wireless communications apparatus, transmitting a cell change indicator to the mobile device, and determining the mobile device changed to the wireless communications apparatus; and
a processor, coupled to the memory, configured to execute the instructions retained in the memory.

35. The wireless communications apparatus of claim 34, the memory retains further instructions related to creating a channel to indicate a serving cell change to the mobile device and using the channel as the cell change indicator.

36. The wireless communications apparatus of claim 35, the memory retains further instructions related to sending the channel on a channelization code used by an E-RGCH or an E-HICH with a signature sequence that is different than the signature sequence of the E-RGCH or the E-HICH.

37. The wireless communications apparatus of claim 34, wherein the instructions related to transmitting comprise sending a −1 on a non-serving E-HICH.

38. The wireless communications apparatus of claim 34, wherein the instructions related to transmitting comprise sending a +1 on a non-serving E-RGCH.

39. A wireless communications apparatus that performs a serving cell change, comprising:
means for receiving an indication that a serving cell of a mobile device is to be changed to the wireless communications apparatus;
means for notifying the mobile device of the serving cell change;
means for detecting a completion of the serving cell change; and
means for informing a network entity of the completion.

40. The wireless communications apparatus of claim 39, wherein the means for notifying comprises means for sending a High Speed Shared Control Channel order to the mobile device.

41. The wireless communications apparatus of claim 39, wherein the means for detecting comprises means for measuring a change from a first scrambling code to a second scrambling code and means for determining the mobile device has switched from the first scrambling code to the second scrambling code.

42. The wireless communications apparatus of claim 39, wherein the means for detecting comprising means for receiving from the mobile device a subset of unused channel quality indicators bits set to “1”, acknowledgement (ACK) bits, or both the subset of unused channel quality indicator bits and the ACK bits.

43. A computer program product, comprising:
a computer-readable medium comprising:
a first set of codes for causing a computer to receive from a radio network controller a radio resource control message that indicates a serving cell of a mobile device is to be changed to wireless communications apparatus;
a second set of codes for causing the computer to transmit a cell change indicator to the mobile device; and
a third set of codes for causing the computer to determine the wireless communications apparatus is serving the mobile device.

44. The computer program product of claim 43, the computer-readable medium further comprises a fourth set of codes for causing the computer to create a channel to indicate a serving cell change and using the channel as the cell change indicator.

45. The computer program product of claim 44, the computer-readable medium further comprises a fifth set of codes for causing the computer to send the channel on a channelization code used by an E-RGCH or an E-HICH with a signature sequence that is different than the signature sequence of the E-RGCH or the E-HICH.

46. At least one processor configured to facilitate serving cell changes, comprising:
a first module that receives from a network a notification that the serving cell of a mobile device is to change from a source node to a target node;
a second module that sends an indication to the mobile device that notifies the mobile device of a serving cell change; and
a third module that detects the mobile device handed off to the target node.

47. The at least one processor of claim 46, further comprising:
a fourth module that receives from the mobile device a subset of unused channel quality indicator bits set to “1”, acknowledgement (ACK) bits, or both the subset of unused channel quality indicator bits and the ACK bits; and
a fifth module that transmits to the network a cell change complete message.

48. The at least one processor of claim 46, further comprising:
a fourth module that detects the mobile device has changed from a first scrambling code to a second scrambling code; and
a fifth module that transmits to the network a cell change complete message.
